(19) United States
(12) Patent Application Publication
(10) Pub. No.: US 2002/0156719 A1
(43) Pub. Date: Oct. 24, 2002

(54) Method and apparatus for trading bonds

(75) Inventors: Murray L. Finebaum, Santa Monica, CA (US); Bradley Levie, New York, NY (US); Trevor Murphy, Amherst, NH (US)

Correspondence Address: MAYER, FORTKORT & WILLIAMS, PC, 251 NORTH AVENUE WEST, 2ND FLOOR, WESTFIELD, NJ, 07090, US

(73) Assignee: Market Axess Inc.,, New York, NY

(21) Appl. No.: 10/001,921

(22) Filed: Nov. 15, 2001

Related U.S. Application Data
(60) Provisional application No. 60/249,849, filed on Nov. 17, 2000.

(51) Int. Cl. G06F 17/60

(52) U.S. Cl. 705/37

(57) ABSTRACT

An Internet based real-time interactive electronic trading system for broadcasting quotes, usually bid and ask prices, for high-yield corporate bonds to buyers and sellers in a fully encrypted manner. Further, it processes orders and executes trades between clients. In addition to fully automating the entire high yield bond trading process, the system maintains a full audit trail of every event in the trading process. The system permits direct but anonymous trading which permits both buyers and sellers to see the price at which they will trade and avoids the need, and cost, for an intermediary. It allows the sale of municipal Bonds in an anonymous and transparent market and allows the purchaser of Municipal Bonds to contemporaneously insure their Bond purchase from default electronically through a municipal bond insurance provider, such as MBIA Insurance Corporation, when making the purchase. The system permits direct but anonymous trading of Convertible debt and Emerging Market Debt as well as providing transparency and liquidity not previously attainable in those markets.

### FIELD OF THE INVENTION

The invention relates generally to methods and apparatuses for electronically trading instruments, and more particularly to a method and apparatus for electronically trading instruments, such as bonds, over a large, distributed, public computer network, such as the Internet.

### BACKGROUND OF THE INVENTION

Years ago equity trading developed under the Buttonwood tree, which served as a physical location at which buyers and sellers could congregate. Over time trading migrated to the New York Stock Exchange.

Today such physical places are no longer necessary to accommodate the assembly of buyers and sellers. Virtual trading locations exist in computers and networks and may be accessed by participants through facilities that already exist in their offices or are easily available to institutions brokers and dealers.

Electronic trading systems have become viable methods for executing transactions in equity securities, U.S. treasury instruments, foreign exchange and commodities. A number of such systems are integral to various markets.

For instance electronic trading systems, including Instinet, regularly account for more than 20 percent of trading of NASDAQ equity securities. In fact, Instinet is often THE principal trading venue for actively trading NASDAQ stocks.

Instinet is a registered broker dealer that operates a trading system for institutional investment professionals including portfolio managers and broker-dealers. The Instinet system provides anonymous two-way computerized transactional capability and continuously updated market information with respect to equity securities traded on NASDAQ and U.S. national and regional stock exchanges and with respect to certain non-U.S. equity securities. The Instinet system enables customers to negotiate trades directly with each other and automatically executes clients matching buy and sell orders. Instinet now has access to over 13,000 users and it is estimated that they have recently traded in excess of 2 billion shares per month.

Additionally, NYSE Rule 390, which prevented member firms from trading certain listed securities other than on an exchange, has been revoked providing an additional opportunity for electronic trading systems to compete directly with the NYSE.

A number of other trading systems serve the U.S. equity markets, including, among others POSIT, and the Arizona stock exchange. Recently there's been an explosive growth by Internet retail broker/dealers, such as E* Trade, e.Schwab, and DLJ Direct. GLOBEX has been used to trade futures and options on futures globally.

The OptiMark™ trading system is a system that allows large institutional investors and others who are concerned about potentially moving the market by placing large orders for equities to place such orders with minimized market impact. It is premised on the concept of a trader having a utility preference function for a particular transaction. As an example, the OptiMark™ system works by having a trader specify how much above the current equilibrium price he is willing to pay to purchase a block of securities. The system then attempts to match that trader's transaction preferences with another trader's preferences in order to complete a trade. The OptiMark™ trading system therefore engages in price discovery.

ITG-Posit is an electronic equity-matching system that lets investors find the other side of a trade during the market day. Posit utilizes mid-point pricing. Buy and sell orders, including individual stocks and portfolios, are entered into the system; five times daily, Posit processes and compares the orders. Posit trades are then priced at the midpoint of the bid/offer spread (the difference between the best seller's asking price and the best buyer's bid) in the stock's primary market when the match is run. Those orders which match are executed. Investors can keep unmatched orders in the system for future matches or can electronically route the order to any one of the primary or regional exchanges, to OTC market makers, or complete the order on an agency basis. Posit is used by major institutions and broker/dealers. Posit, like the OptiMark™ trading system, is in essence a matching system but Posit matches trades at the mid-point (as determined by a third party system) without independent price discovery. It is premised on traders wishing to trade with each other and provides such traders a potentially better execution (because of the mid-point cross) with lower market impact (because of the anonymity of the trades and the increased available liquidity based on the concentration of trades within certain time frames).

Previously, the high yield bond market was a telephone-based market, wherein each trader had to contact another trader to ascertain interest in a trade, the quantity and the price. This method was not only extremely slow, tedious and labor intense, but the process also revealed, per force, which individual in the trade was more motivated to trade and, by extension, more likely to pay a premium. This lack of anonymity gave a further trading advantage to one side, in that once the identity of the initiating trader was known to the solicited party, other non-market factors known about that trader could cause subtle but real additional premiums to be incurred. This leads to significant inequities in bond trades and traders.

U.S. Pat. No. 5,915,209 discloses a bond trading system. The computer-implemented bond trading system disclosed therein provides the capability to conduct a private electronic auction of bid wanteds between a central broker's broker and multiple prospective remote bidders. Moreover, this system maintains a database of accurate bond lot descriptions and identifications, notably CUSIP numbers. Bids are transmitted from a bidder to a central market maker, who then broadcasts the bids to prospective bidders along with a time for responding. This enables a private auction not unlike a sealed bid auction.

The present invention is therefore directed to the problem of developing a method and system for trading bonds that removes the inequities inherent in bond trading.

### SUMMARY OF THE INVENTION

The present invention solves these and other problems by providing a system and method for trading bonds that enables traders to enter trading orders in a truly anonymous manner, thereby providing a bond market that is solely influenced by true market pricing and not by external, non-market influences.

One exemplary embodiment of the present invention includes inter alia a real-time, Internet-based, electronic bond trading system that displays all active orders in any bond (i.e., the bond's book). Although the system displays trading orders, the system protects the identities of the traders whose orders are being displayed. The user is able to interact with any order, manage his own orders in real time, and obtain real-time information on his orders and trades.

These and other objects and advantages will become readily apparent to those of ordinary skill in the art upon reading the Detailed Description and Claims to follow.

### BRIEF DESCRIPTION OF THE DRAWINGS

FIG. 1 depicts a block diagram of an exemplary embodiment of a system according to one aspect of the present invention.

FIGS. 2A-Z and 3A-B depict various screen shots from exemplary embodiments of a graphical user interface according to another aspect of the present invention.

FIG. 4 depicts a block diagram of an exemplary embodiment of a failover subsystem according to yet another aspect of the present invention.

FIG. 5 depicts a work flow diagram of a conventional process for insuring a municipal bond.

FIG. 6 depicts a work flow diagram of a process for insuring a bond in conjunction with a simultaneous purchase of the bond using an electronic bond trading system according to yet another aspect of the present invention.

FIGS. 7A-B depict another process for purchasing a bond and insurance for the bond as a simultaneous transaction according to a further aspect of the present invention.

FIG. 8 depicts a process for purchasing insurance using an electronic bond trading system in which the bond has already been purchased according to yet another aspect of the present invention.

### DETAILED DESCRIPTION

At this point, it is worthy to note that any reference herein to “one embodiment” or “an embodiment” means that a particular feature, structure, or characteristic described in connection with the embodiment is included in at least one embodiment of the invention but not necessarily all embodiments. The appearances of the phrase “in one embodiment” in various places herein are not necessarily all referring to the same embodiment.

The present invention provides a completely anonymous, computer-based order entry, controlled offer-disclosure and trade execution system designed specifically for bonds, including high-yield, corporate, emerging market and municipal bonds. As a result of certain aspects of the present invention, traders may controllably disclose bond trading orders to the system, which disclosed orders (i.e., bids or offers) are provided to all users without attribution (i.e., without identifying the trader submitting the offer).

A trader when submitting his offer to the trading system may disclose part or all of an offer (either a buy or a sell) to other traders using the system. Thus, for the first time a bond trader has a current, real-time view of the market in a particular bond, as well as an historical view of the market in that same particular bond. This enables the bond trader to more accurately price the bond, thereby reducing the spread in bonds (and, of course, the related inefficiency in trading bonds) and potentially improving the liquidity of these instruments.

Every executed bond trade is reported to all users in a scrolling ticker updated in each user's graphical user interface on a continual basis. The scrolling ticker includes subsections for the various bond markets being served, such as high-yield bonds (sometimes known as junk bonds), corporate bonds, municipal bonds, emerging market bonds, convertible bonds, etc. Moreover, by enabling bond traders to quickly view related markets, traders can for the first time detect trends across markets and take advantage of opportunities previously undetected.

While equities have had complex systems for reporting trades, no such equivalent exists for bonds. Thus, one aspect of the present invention provides this capability for the first time for bonds. Moreover, as the trading volume and offer volume in bonds is significantly reduced compared to equities, updating the scrolling tickers using Internet-based communications is possible without straining network resources. Finally, the historical basis provides analysts the capability for the first time to more accurately price bonds, thereby reducing the spread in bonds, which is significantly higher than in equities.

Thus, the system reports both disclosed orders and executed trades to all users. As a result of this aspect of the present invention, users have a real-time and an historical view of the market in any given bond, whereas the results of bond trades were previously reported on a significantly delayed basis, if at all.

One exemplary embodiment of a bond trading system according to one aspect of the present invention includes an Internet-based bond trading system utilizing a client-server architecture that enables users that are connected to the Internet to access the bond trading system without acquiring unique hardware or dedicated communications facilities. Thus, the present invention leverages the communications infrastructure provided by the Internet with software that executes on a user's personal computer to provide an easily accessible, widely available system. As a result of the use of this architecture, bonds available for trading in the U.S. market are now made available to traders worldwide—thereby significantly increasing the liquidity of the market in these bonds. Moreover, this aspect of the present invention makes possible a global bond trading market that was heretofore not possible. Furthermore, the present invention consolidates the various bond markets into a single market, whereas previously the various bond markets have been isolated and disparate markets.

As this embodiment of the bond trading system is an open system, which is theoretically accessible by anyone with a computer, there is a need for a particularly strong security protocol. Thus, an embodiment of the bond trading system of the present invention allows only authorized users to access the system by employing multiple layers of security. This embodiment is designed to ensure that access is restricted to authorized clients, utilizing various combinations of passwords, encryption, digital certificates and other security devices.

To further protect from unauthorized access and hacking and to inter alia recover in case of an attack, an embodiment of the system automatically creates an audit trail that records every event at the server and determines what acts authorized users have taken in the event of a subsequent dispute. As part of the audit trail, the server time stamps all activity, including time of receipt of any order, time of execution, as well as all logins and connection status. In addition to the time stamping, the embodiment of the system records the state of each record before and after the change, thereby enabling a return of the database to a prior moment in time.

The system confirms receipt of orders and transactions to all users. It also broadcasts bids and offers, as they are entered, to all users who are logged in as well as reports of transactions and displays the “book” of orders for any instrument traded. All orders entered into the system must be priced and contain a quantity. All orders submitted by a trader are firm and executable on-line. Therefore, until cancelled, a bid or offer entered into the system remains valid and may be traded against confidently by another trader.

In orders that include time limits, the system automatically cancels these orders upon the expiration of the specified time limit—such as time of day, good for a set period of time, or for the day. The conventions for trading particular securities are displayed on the user screen. Thus, a trader may enter a time limit with each bid or offer, causing the bid or offer to be cancelled if not traded against within the specified time.

Additional features of the embodiments include the ability of user to review orders that he has placed in the system and trades executed for his account. In addition users can obtain reports on their trades and orders by date range and/or by instrument. The system accommodates orders that do not display their entire size, which are marked “Show Only,” as well as other conventional trading conditions, such as All or None, Fill or Kill, Minimum Fill, and “Lots of,” which requires contra party traders to buy in specified lots.

The bond trading system of the present invention utilizes widely accepted telecommunications information processing to create a low-cost, transparent virtual meeting place in which an institutional investor can trade “directly” with a counter party without the need for an intermediary. Dealers may also participate in the system.

A transaction support desk actively audits the bond trading service. All trades and orders are reviewed by the transaction support desk that alerts other subscribers with a potential interest to a bid or offer using either the systems messaging facility, email and or a telephone call.

The transaction support desk can add new bonds to the system in real time upon request by an authorized user. If a particular trader wishes to trade a bond not listed in the existing database, the trader simply calls the transaction support desk, requests the bond desired, and the operator adds the bond to the database from the complete list of bonds supplied by the bond data information service, such as J. J. Kenny or its equivalent.

As the system requires no unique customer equipment or network it does not require any field service other than assistance to customers having Internet connection problems. Users establish communications with the bond trading system through their Internet service provider. To gain access to the system, digital certificates are installed on the client workstation, and users define the passwords. The bond trading system provides different levels of access, currently divided into those users granted trading privileges and those not able to trade. The bids and offers are anonymous, i.e., only the control center is aware of which user is making a given entry or trade. This enables the control center to monitor offers that are being entered and manually generate contra trading interest by notifying potential bidders of offers of which they may be interested.

All trading orders are priced and include a quantity. Conditions such as “all or none,” “fill or kill,” “minimum fill” etc. may be attached to any trading orders; codes for these industry standard conditions are then displayed next to the bids and offers when they are displayed to all other users. The industry conventions for trading particular bonds are displayed on the screen.

Users enter their own trading orders into the system. The system confirms entries to the entering terminal and displays all activity (bids, offers and trades) in real-time in a continuous tape adjacent to the book of orders in a given security. All orders entered into the system are broadcast to other users. Orders of which a portion is not displayed are accommodated, but executions occur up to the entire (not just the displayed or disclosed) size.

A user entering orders may cancel or modify each of its orders to the extent not theretofore executed. In addition, users' orders will be canceled when they log off the System, when the workstation loses connectivity with the System, and if user's access is terminated by the system.

Transactions are reported to the users involved who also have access to the trade blotter maintained by the system. Clearing information is reported to a clearinghouse, such as Schroders, which is used by the system for all trades, at the close of trading day. Users may allocate transactions among managed accounts and may select multiple trades of the same instrument on the same side (buy/sale) and average price those transactions.

The system maintains an audit trail that records time stamped entries for all actions in the system such as logins, log outs, loss of communication, order entry, order revisions and trade details. These records are maintained for the appropriate periods and remain accessible in accordance with Securities and Exchange Commission (SEC) and National Association of Securities Dealer (NASD) rules. System operators can, in real-time, track the usage of the system by users, view orders placed into the system, and transactions executed, and authorized new and terminate existing, users.

The environment in which the system operates runs plays an important role in securing the system and providing a robust, high-quality service. The programs used to operate are written entirely in the JAVA programming language. The system uses a multi-tiered architecture to assure scalability of its service.

JAVA is a high-performance, multithreaded, portable, robust and secured programming language that is Internet-savvy. It enables the construction of secure, virus free and tamper-free systems, qualities that are essential for online trading environments. Programs written in JAVA are not subject to the typical memory leaks and memory corruption problems associated with many other programming languages, making JAVA programs significantly more reliable and secure. JAVA programs cannot gain unauthorized access to memory, so they cannot interfere with other programs running on the same machine.

An embodiment of a system according to one aspect of the present invention runs on Sun Microsystems JAVA Virtual Machine (JVM). The service is not dependent on any software already installed on the users PC. Any other software installed on the host machine at any time, including Web browsers and other JVMs, does not affect the service. Sun's JVM is a robust, secure, reliable, portable and standards-based implementation. Other JVMs, including those bundled with some of the leading Web browsers are not yet fully compliant with the JAVA specification.

The embodiment is also self-updating. As new versions of the software are made available the installed users software is automatically updated. This insures that uses are always using the most secure and current version of the service software.

The embodiment uses various application transport level protocols to secure the communications between clients and the system's servers. The underlying data transport protocol is the standard Transmission Control Protocol (TCP), which provides reliable, ordered network communications channels. The fundamental application level communication protocol is the Secure Sockets Layer (SSL) v3.0. SSL provides a communication channel that is highly resistant to hijacking, tampering, and eavesdropping.

SSL provides such secure communications through three main connection security facilities: message integrity and reliability, authentication of the server (and optionally the client) in a totally private communication channel. Message integrity and reliability are insured by the use of crypto graphically strong hash function used as a keyed MAC (Message Authentication Code). The client and server authentication are implemented via X.509 styled digital identificator certificates, which use public-key cryptography to authenticate each entity. The communication channel is made private by creating and using a symmetric, secret encryption key, which only the client and server share.

The embodiment uses a standard SSL port 443, which supports firewalls, including proxy-based firewalls that allow SSL traffic in and out. Authentication of users of the Service is an integral facet of the security design and implementation. All users must pass several steps before getting access to the client software installation program, let alone use the service.

Once the system has authorized a user, an account is created with a user-name and a password, which are tied to the clients firm and, the appropriate user access permissions. During the client installation phase a digital certificate for the users is created. This digital certificate adheres to the X.509 digital certificates standard. It is impossible for anyone but the system to sign any digital certificate that will be accepted by the system. The combination of valid username, password, company name and digital certificate grants a user access to the system.

An Access Control List (ACL) controls every possible action in the embodiment. The embodiment checks to see if the client is in the appropriate ACL before the client is allowed to perform any actions, such as placing in order, allocating a trade, or just viewing the service. Therefore, if the user is not on the appropriate ACL, the user is not allowed to perform that action. These ACLs are enforced in both the client and server. This combination of procedures in conjunction with the password system described above creates a robust, secure system for bond trading which can then be implemented in an otherwise open, freely accessible public network environment, such as the Internet.

The Trading Edge Transaction Support Desk has the ability to change these ACLs in real-time. It can grant, deny or modify the permissions a user has in the system instantaneously. The Service logs all system and client actions to a logging system including login, as well as placing, modifying and canceling orders. The logging system records all actions in strict time priority and these logs are audited regularly. The auditing system is implemented completely separate from the Service server software so there is no way for any action to escape being logged.

The combination of robust security and the auditing system provides a powerful protection against would-be hackers or unauthorized users.

### APPLICATIONS TO ADDITIONAL MARKETS

In addition to the high-yield debt market, embodiments of the systems are designed to readily handle bond trading in most other debt instruments as well. Institutions are the principal investors in these markets, and the secondary and municipal markets are a sizable element. Each of these markets benefit from the transparency and anonymity provided by one or more aspects of the present invention.

For example, a number of institutional clients routinely purchase new issues to assure that the underwriter will include them in other underwritings. To dispose of excess inventory, these institutional clients need a secondary market to dispose of some or all of their positions. One aspect of the present invention provides this secondary market. Similarly, the underwriter may wish to participate in the same market, consistent with regulatory constraints, to anonymously condition the market for the offering and for stabilization post offering.

Debt instruments issued by Third World countries, known as “Emerging Nations,” has created the need for a liquid market in these instruments. The system of the present invention can accommodate trading in these instruments, thereby markedly improving their liquidity, while also providing the anonymity necessary to further improve the liquidity of the market in these instruments.

Convertible debt instruments represent another market in need of the anonymity and liquidity provided by certain aspects of the present invention. The system of the present invention can provide this market with the ability to trade electronically and to global participants.

Municipal Bonds are traded in a market that is currently broad but fragment. Typically, market makers are regional dealers that make markets for the instruments issued by local governments. There is no coherent national electronic trading market for these municipal bonds. For the first time, the present invention permits electronic bond trading with the accompanying anonymity and liquidity in this municipal bond market.

In addition to providing liquidity and anonymity, another aspect of the present invention enables the system to offer insurance against default to purchasers contemporaneously with the purchase. This insurance is offered through a third party municipal bond insurance provider, such as MBIA. This makes possible for the first time a transaction that includes all costs associated with the investment before the investment is completed, thereby enabling an investor to determine the actual opportunity presented by the investment vis-\dot{a}-vis other opportunities. By providing the trader with the complete transaction cost as well as a view into other similar but distinct markets, this aspect of the present invention enables traders to better select the correct investment opportunities. Moreover, by presenting the trader with the insurance cost before the trade, traders are more likely to investigate (and request a quote) for the insurance, thereby increasing the liquidity in insurance on these instruments. By reducing the transaction costs associated with these insurance quotes by implementing them in a seamless, electronic fashion, this aspect of the present invention reduces the cost of providing this insurance, thereby making transactions in municipal bonds that are insured more competitive vis-a-vis other debt instruments.

Investment-grade bonds are traded on a different basis than other debt as they are compared to the Treasury Department bond yield curve. One aspect of the present invention provides a similar market for these bonds.

The invention includes embodiments of an electronic trading facility for trading Derivative Instruments as well. Derivative instruments derive their value from other instruments. Often, these instruments are created to address specific needs of certain large investors. However, by providing a market for trading these instruments other investors with similar needs can be determined, which other investors may not otherwise be known. These embodiments include many of the same features discussed in relation to the other embodiments.

In summary, the system utilizes the latest advances in security design and implementation, including public key cryptography authentication and private key incryptic data communications to ensure the security of all aspects of trading debt instruments in an anonymous and secure environment accessible over the Internet. The use of full-time, reliable Internet connections and operations which can now be obtained from the Internet service providers users continued and uninterrupted operation of the market without requiring the client to use dedicated equipment or communications links. Moreover, the investments others make to the improve the communications capability of the Internet will benefit the users of this trading system. The present invention provides inter alia a virtual marketplace for the purchase and sale of high yield debt instruments and other debt instruments through the unique combination of secure communication and versatility of Internet communications.

Exemplary Embodiment Overview

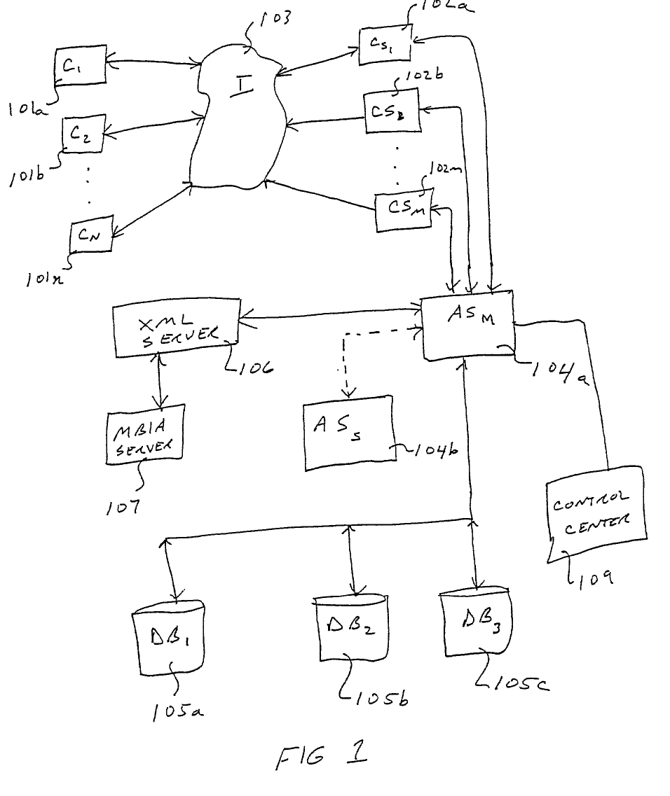

Turning to FIG. 1, shown therein is an exemplary embodiment of a bond trading system according to one aspect of the present invention. A client application executes on several workstations or personal computers 101a-101n. One exemplary embodiment of the client application is a JAVA program that can execute on any workstation independent of the operating system. The client application may also be written in other programming languages. One possible implementation of the workstations 101a-1012 is a standard personal computer, such as an IBM compatible computer with an Intel Pentium-based processor and a Microsoft Windows 95/98/2000 operating system.

The workstations 101a-n are coupled to multiple connection managers 102a-m via the Internet 103 or other computer network, such as a local area network (LAN). Multiple connection managers 102a-m serve to handle accesses by multiple workstations 101a-n simultaneously. There may be different numbers of connection managers 102a-m and workstations 101a-n. Moreover, each connection manager 102a-m can handle multiple workstations 101a-n. One possible implementation of the connection manager is a SUN 250 workstation with two computer processing units (CPUs). Another possible implementation is a Dell 4300 computer. The connection managers serve as gatekeepers for the application server 104. The connection managers perform authentication and encryption to validate each user and user transmissions. Moreover, the connection managers provide a constant communications channel between each user to ensure the security of the access.

The application servers 104s, 104m are configured in a standard master-slave architecture that allows for a complete backup should the master application server 104m fail. One possible implementation of the application servers 104s, 104m is a SUN 450 workstation with four CPUs executing WebLogic 4.5.1 and Java 1-22 for Solaris and Java 1-3 for Windows NT/98/95/2000. Another possible implementation of the application servers 104s, 104m is a Dell 4300 computer.

The application server 104m is coupled to three identical databases 105a-c to ensure backup. One of the databases is located off-site from the others to protect against local disasters. One possible implementation of each of the databases 105a-c is a Sun 450 workstation with four CPUs executing Oracle 8.1.6. Another possible implementation of the databases is a Dell 6300 computer executing a relational database, such as Oracle 8i.

Also coupled to the Application Server 104 is an XML server 106 which is coupled to a server 107 via a direct connection (or dedicated line). Server 107 is disposed in a bond insurance provider and accepts requests for bond insurance and outputs quotes in response to these requests. These servers 106, 107 may be similar to the application servers 104.

Also connected to the application server 104 is a control center server 109. The control center server enables a system operator to monitor all activity in the system and to perform system level diagnostic and testing and maintenance.

Exemplary Operation

One exemplary embodiment of a system according to the present invention operates as a broker/dealer. This embodiment operates an Internet bond trading service in accordance with the following on-line procedures. The computerized bond trading system maintains the anonymity of all participants, subject only to regulatory requirements, and legal processes. All orders entered into the trading system are fully executable on their terms until they expire or are cancelled. There are no “subject” orders. To maintain this feature, the system prevents operations staff from entering or modifying orders on behalf of users. The operations staff may cancel resting orders, however, it is quicker for a user to do so through the graphical user interface executing on the user's workstation.

All orders entered into the service must be priced. All orders will be broadcast and displayed to all users, except Fill or Kill orders. Trades are executed on the basis of strict price/time priority for the quantity disclosed to other users/traders.

Of course, trading conditions set by a user may prevent a transaction. For instance, if a user sets an “All or None,” condition his/her order may lock or cross another order.

A “Show Only” order has a time priority in the queue of orders at its price only for the quantity shown to other users. Revealed quantity takes priority in the queue when it is displayed to other users, in the amount in which it is displayed.

Any modification of an order (such as, quantity, price, time of expiration, Show Only, All or None, Minimum Fill or Lots Of) results in cancellation of the resting order, and the entry of a new order with a new time priority.

Orders for odd lots may be entered into the service. Users can avoid odd lot executions by setting “Minimum Fill and/or “Lots Of” conditions when placing orders.

The service places limits on certain input amounts. The “Quantity” field in the Buy/Sell order form must be less than $100,000,000 face amount. “Show Only” and “Minimum Fill” must be greater than or equal to $100,000 face amount and must be greater than or equal to the “Lots Of” quantity. The “Lots Of” quantity must be greater than or equal to $10,000 face amount. In addition, the “Show Only” quantity must be the greater of $100,000 face amount or 10% of the total quantity of the order. The service will ask for confirmation for any order for $10 Million or more face amount.

When an “All or None” order condition is selected, a superscript “^{A}” will be displayed next to that order in the Book. When a “Minimum Fill” order condition is utilized in the Book, a superscript “^{M}” will be displayed with the “Minimum Fill” quantity required for the condition to be satisfied. When a “Lots Of” order condition is utilized in the Book, a superscript “^{L}” will be displayed with the “Lots Of” quantity required for the condition to be satisfied. When there are multiple conditions to an order, the service will display by order of priority, each condition, into the Book.

When a user places an order, it will be displayed in the scrolling ticker and in the Book for the security with a “+” which identifies it as the user's order. The “+” will not appear on any other user's workstation.

All active orders of a user are cancelled upon exiting the service or the service determines that the user has lost his/her connection to the service. All orders are also cancelled when trading closes, or if the service experiences a service-wide interruption

All trades are executed by the system on a riskless principal basis, with markups/markdowns disclosed. Users will see the transaction price, net price and net yield to maturity, as well as the net settlement monies, before an order is entered.

The net price equals the transaction price, net of markup/markdown and, if applicable, insurance purchased for the bond.

The operators of the system and the system never trade for their own account and risk.

The system may suspend trading in any individual security during the trading day. This may occur when the system determines that the trading conventions of a security have changed.

All transactions executed through the service will be cleared and settled through a clearance company, such as Depository Trust Company. Users may allocate all trades after the service closes for trading.

Once the user average prices two or more trades, the averaged priced trade cannot be reversed, although additional trades may be added to an averaged priced trade. The user must contact the Transaction Support Desk for any corrections, which will be made with, for example, Schroders/Lewco Securities. These changes will not be reflected in the system database.

Matching Routines

The service matches trading orders according to the following rules: All orders are matched in a strict price/time priority. Within each price queue, each order has a time priority established by the time of entry for the quantity disclosed to other users. Order conditions may prevent a match from occurring. In such an event, a locked or crossed market may result. Users may unlock or uncross a market by, e.g., entering an order with a better price than the displayed order locking or crossing the market, even if the order has a minimum price difference between the displayed order locking or crossing the market. Moreover, under certain conditions trading may then occur at a price less than the newly entered better price. In sum, a locked market can be effectively unlocked without necessarily causing a trade to occur at a better price than the order locking the market.

The following is a list of the service's actions for various order conditions:

FOK=Fill or Kill—Immediately fill this order in its entirety or the order will be cancelled.

AON=All or None—Fill the entire quantity of this order.

MF=Minimum Fill—Fill this quantity initially. Remaining balance has no conditions, unless specified.

LO=Lots Of—sets a condition of minimum execution in lots

SO=Show Only—Manages the display of quantity.

GU=Good Until a time of day—sets the time of order expiration in terms of a time of day.

GF=Good For a period of time—sets the time of order expiration in terms of hours and minutes.

QTY=Quantity, including remaining quantity

Orders with the following conditions may not be entered into the service:

QTY greater than $100,000M

FOK and AON

FOK and MF

FOK and SO and LO

AON and SO and LO

FOK and LO

FOK and MF and LO

FOK and MF and LO and SO

FOK and SO

FOK and GU

FOK and GF

AON and MF

AON and LO

AON and MF and LO

AON and MF and LO and SO

AON and SO

AON and SO and LO

MF less than $100M

MF less than LO

MF more than QTY

LO not a multiple of QTY

LO less than $10M

LO not equal to or a multiple of MF

SO less than $100M

SO greater than QTY

SO less than MF

LO not a multiple of SO

Fail-over Subsystem

One exemplary embodiment of a bond trading system according to another aspect of the present invention employs a fail-over subsystem that ensures near transparent failure resolution for all tiers of the system (see FIG. 3). These tiers are defined as follows:

Tier 1: Client—Workstation 101, Control Center 109, Authenticator.

Tier 2: Connection Server 102a-b—Maintains client connectivity, services database read operations, proxies events to clients.

Tier 3: Application Server 104s, 104m—Services database write operations, matches trades, generates events.

Tier 4: Database 105a-b—Distributed persistent storage.

Client connectivity is best viewed as a “chain” of connectivity between the client 101 and the master application server 104m. This chain currently involves two connections: client 101 to connection server 102 and connection server 102 to master application server 104m. For a client session to be active, this chain must be maintained. Upon startup, a client 101 has a list of possible connection servers 102a-n that it can connect to. It proceeds through this list in a random order until it finds a connection server 102a-n that will accept its login request. After authenticating a user, the connection server 102a-n proxies the login request to the master application server 104m. Once logged in, the connection server 102a-n acts as the single point of contact for the client 101, servicing read-only requests directly from a database, proxying write requests to the master, and monitoring the client's connectivity.

A connection server 102 maintains connectivity to one database server 105 from which it reads data, and to the master application server 104m. When these two connections are active, the connection server 102a-b can establish and maintain client connections.

An application server 104 maintains connectivity to two databases 105. As long as these connections are up and the application server 104 is designated as the master (see below for more on “master”), the server 104 can establish/maintain connections from connection servers 102a-b.

Overview of Failure Handling

If there is a hardware or software failure on the server system side (tiers 2-4), servers detect the failure and react to reestablish a functioning system. Clients should reconnect to the system (if their connections went down) and receive information that they missed during loss of connectivity.

A client session is only valid as long as the connectivity chain between the client and the master application server remains intact. If the chain is broken and not reestablished within a set grace period, all the client's orders must be cancelled.

Application Servers perform the following failover functionality. The application servers coordinate among themselves as to which application server is the master, and of course, which application server is the slave or which application servers are slaves. At any given time, there must be zero or one master application server. Being designated the application server master means that an application server is the primary point of contact for matching, event generation and any application operation that changes the database.

There can be any number of slave application servers. When the current master fails or is brought down for administrative purposes, one of the slaves will promote itself to master. During certain conditions, a ControlCenter Admin client can specify which application server slave will become master application server when downing the current master.

The application servers always ensure that there are two or more active database servers. The application servers monitor client sessions and cancel orders when clients logout or are no longer connected to the system and have exceeded a re-connect grace period.

The application servers monitor connection server connectivity. If a connection server disconnects and a re-connection grace period has been exceeded, the application server cancels all orders for all clients that were connected through that connection server. In addition, the application servers maintain database consistency by reacting to database failure.

Connection Servers perform the following failover functionality. The connection servers monitor and maintain connectivity to the master application server and one active database server. The connection servers accept and maintain client connections only when both of these connections are up. Moreover, the connection servers proxy all RMI methods that perform database writes or generate events to the master application server.

The Database Servers perform the following failover functionality. The database servers ensure that all writes to the database are done via a distributed transaction to all active databases. The database servers report database exceptions to the master application server when a database server cannot be written to.

The clients perform the following failover functionality. The clients maintain connectivity to an active connection server, and detect when connectivity to a connection server is down or has encountered an unacceptable delay. The client reestablishes and resynchronizes with the server when loss of connectivity occurs.

To maintain the system in an active state, there are minimum numbers of connection, application and database servers. If the minimums are not met, the system is in an inactive state. The minimum requirements for an active system include one (1) active connection server, one (1) master application server, and two (2) active database servers, as well as one (1) connected Control Center client (for trading day to remain open). If at any time these conditions do not exist, the system does not allow trading and blocks workstation (and client) connectivity.

Application Server States

Application servers can be in the following states:

STARTING: before the server has initialized and discovered adequate information to know its state.

READY: before a MASTER is selected manually

MASTER: focal point for trade matching, event generation, database writes

SLAVE: monitors MASTER's state and is ready to promote

DOWN: the server has failed an internal test

ADMIN DOWN: the server has been brought down by a Control Center Admin user for administrative purposes.

INTERVENE: the server has gotten conflicting information from another server and cannot continue in an active role.

When the system starts up, all application servers that have passed their internal test are in the READY state. A Control Center Admin client has the ability to promote one of these servers to MASTER, after which all other READY servers become SLAVEs.

Application servers publish their current state (i.e., master, slave, down, etc.) every few seconds. Each application server maintains state information on other application servers by listening for these events, and testing RMI connectivity and network connectivity. If an application server fails its internal test, it will demote itself to the DOWN state.

When a SLAVE fails to receive a status event from the most recent MASTER within a configurable grace period, it attempts an RMI call to the server (synchronous). If this fails, the server attempts a network level ping of the server. If this ping fails, the SLAVE cannot promote to MASTER as it may be disconnected from an active MASTER. If the network test succeeds, the SLAVE decides that the server is down. It next goes to the database to see if it is the next active SLAVE in line to be MASTER. If it is and it has passed its internal test, it will promote.

An application server must maintain connectivity to two databases in order to remain in the MASTER, SLAVE or READY state. An application server must maintain connectivity to at least one Control Center to remain in the MASTER state. One of the two databases that an application server is connected to is its primary database. If this connectivity test fails, the MASTER cannot reconnect to another database but must bring itself DOWN. If the second database connection test fails, the backup database test, the application server is free to attempt to find another database. If it fails to find another backup database, it must demote itself into the DOWN state.

The MASTER application server maintains in memory (and also in the database) client session information. When a connection server tells the MASTER that a client is disconnecting, all the client's orders are cancelled. The MASTER monitors connection server connectivity via a periodic ping mechanism. This is implemented with Tengah events (request) and RMI (reply). If the ping fails, orders for all clients connected through the failed connection server are cancelled (unless the connection is reestablished within a set grace period).

The MASTER application server performs all writes to the database. If a write to one of the active databases fails, they handle the exception from the database server by performing 2 operations: (1) marking the database as inactive (in all reachable database); and (2) notifying other servers of its failure.

Connection Servers

Connection servers continually try to maintain a database connection and a connection to a MASTER application server. The database connection is tested every few seconds. Connectivity to the MASTER is maintained via a ping mechanism initiated by the MASTER upon connection server registration. If connectivity to either the database or the MASTER fails, the connection server fails and issues a command to its clients instructing them to reconnect, unless the connectivity is reestablished within a set grace period. Connection servers are durable and can recover from both database and application server disconnection. Once a connection server reestablishes the failed connection, it can once again accept client connections.

The connection server monitors client connectivity using the same ping mechanism that the application server uses to monitor connection server connectivity. If the ping mechanism fails, the connection server notifies the application server that the client is no longer connected. If the client does not reconnect to a connection server within the specified grace period, the application server cancels all the client's orders.

Database Servers

Database servers use distributed transactions to write information to three databases simultaneously. They do not commit a transaction until all of the active database servers have been written to via a distributed 2-phase commit. If a write fails, the database servers notify the caller (MASTER) application server of the error via an exception. The master application server will end up marking the failed database as inactive and system operation will continue without that database (as long as there are two or more databases still in the active state).

Clients

Clients establish a connection with a connection server and maintain it by replying to ping requests. If the ping mechanism does not receive a ping request in a set amount of time, the client will attempt reconnection to another connection server. If this succeeds, the client asks for all the events that it missed while it was disconnected. The client will cycle through the connection servers 2 times or until a configurable grace period has expired (there's no sense in continuing if the time to reconnect exceeds the time after which the MASTER will expire the session).

Message Configuration Options

The failover subsystem uses three periodic messages to discover and determine the state of Application Servers, Connection Servers and Clients. Each of these messages has a period at which the message is sent and a timeout after which the sender and listener of the message decide that the other party is no longer present. The failover subsystem has its own timeouts because the TCP/IP timeout is too large to meet the requirement that orders be cancelled in a timely fashion upon client disconnection. The three message types and their parameters are as listed in the following table.

| Message | Description | Params (periods in milliseconds) |
|---|---|---|
| AS Pulse | Each AS sends out a | int publisherPulsePeriod - |
| | state pulse and listens | period of pulse |
| | for and reacts to | int subscriberPulsePeriod - timeout of |
| | other AS state pulses. | listener |
| CM Ping | The master AS pings | int cmPingPeriod - |
| | each CM. Both | period of ping from AS to CM |
| | parties use the ping | float cmPingSourceTimeoutFactor - |
| | to assess their | timeout factor applied to |
| | connectivity. | cmPingPeriod to get AS timeout |
| | | float cmPingTargetTimeoutFactor - |
| | | timeout factor applied to |
| | | cmPingPeriod to get CM timeout |
| Client | Each CM pings its | int clientPingPeriod - |
| Ping | clients. Both parties | period of ping from CM to Client |
| | use the ping to assess | float clientPingSourceTimeout |
| | their connectivity. | Factor - timeout factor applied to |
| | | clientPingPeriod to get CM timeout |
| | | float clientPingTargetTimeoutFactor - |
| | | timeout factor applied to |
| | | clientPingPeriod to get Client timeout |

These parameters are in the following two classes:

com.tradingedge.framework.server.ServerFailoverParameters.java

com.tradingedge.framework.common.CommonFailoverParameters java

These parameters may be moved to a client side properties file in order to configure them on a per client basis.

Additionally, there are two parameters called dbGracePeriod and asGracePeriod. These specify the number of milliseconds that a CM can remain disconnected from a DB or an AS respectively before disconnecting its clients. During the grace period, the CM attempts to reestablish connectivity to either the same or another DB/AS. These parameters are in the following class:

com.tradingedge.framework.common.CommonFailoverParameters.java

Graphical User Interface

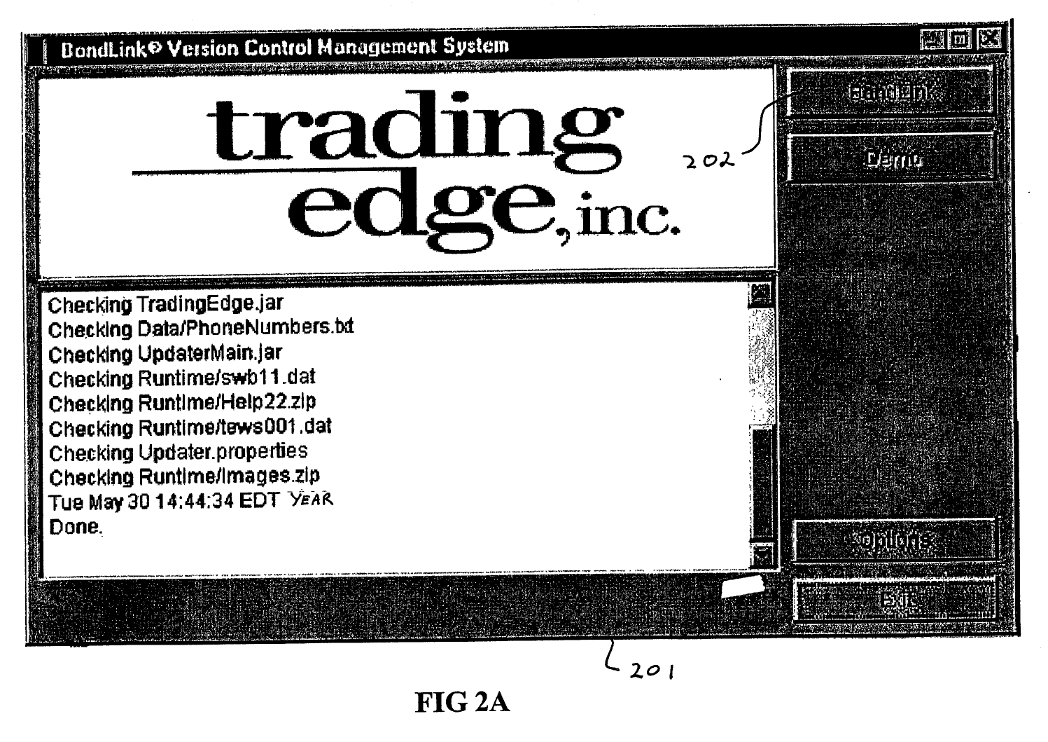

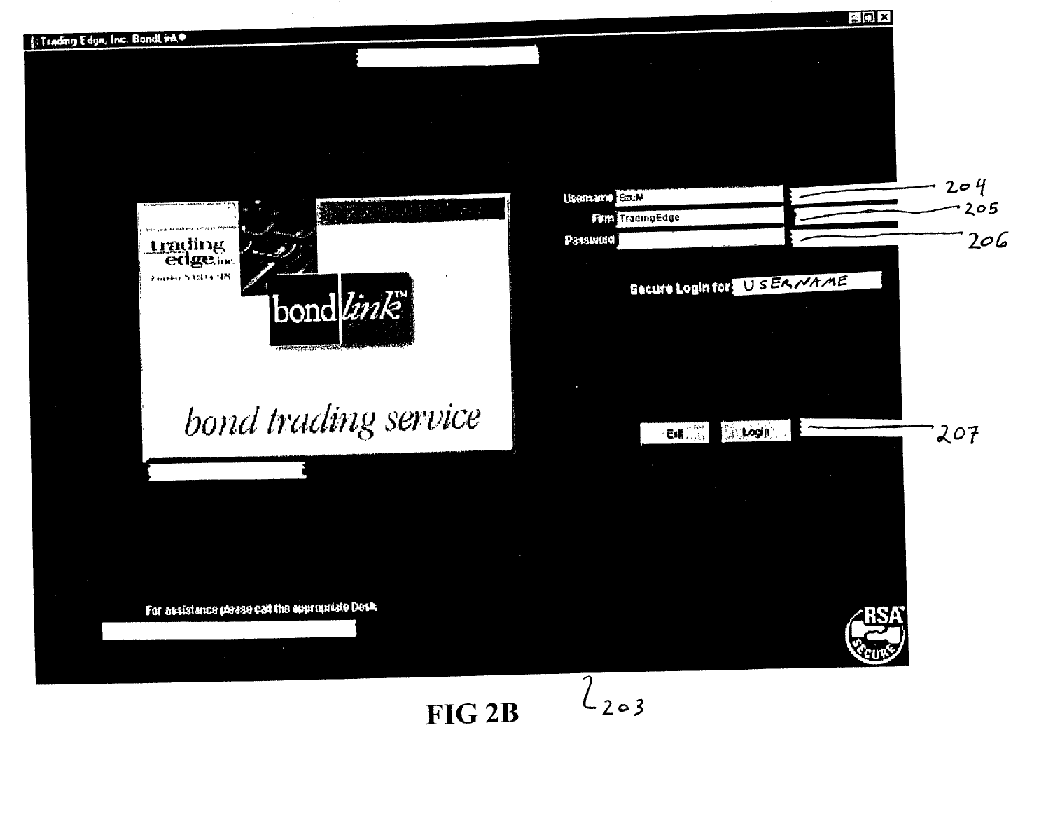

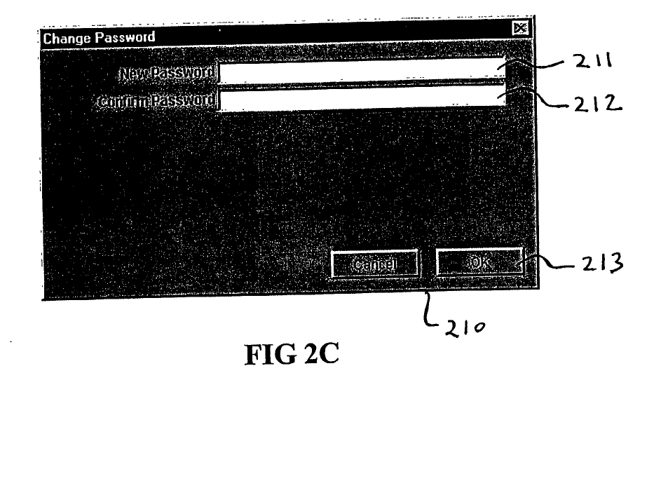

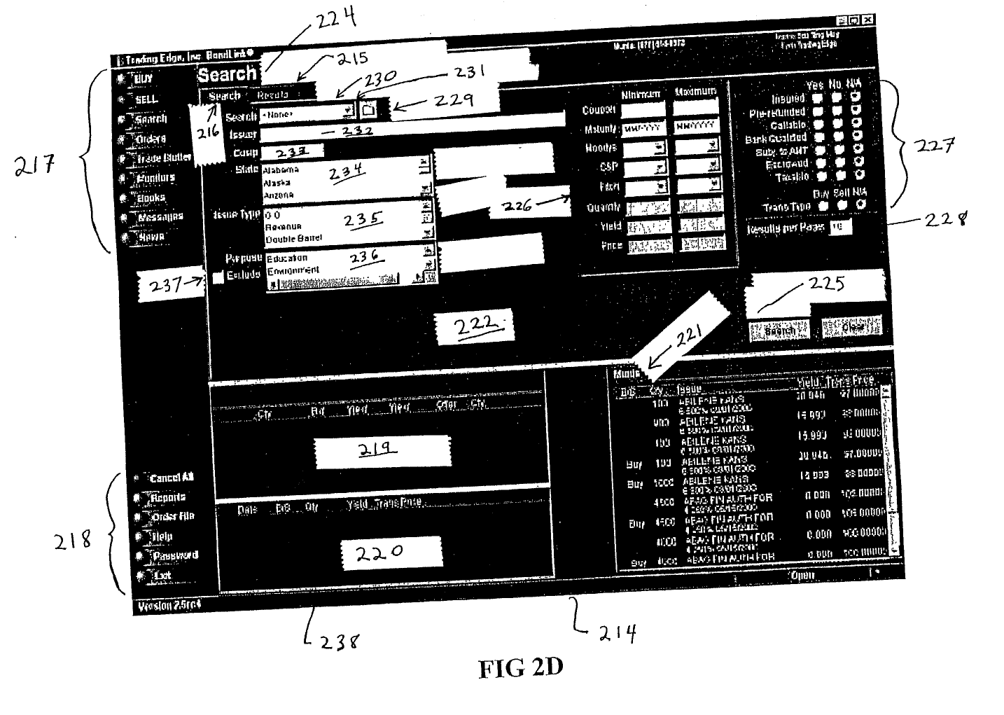

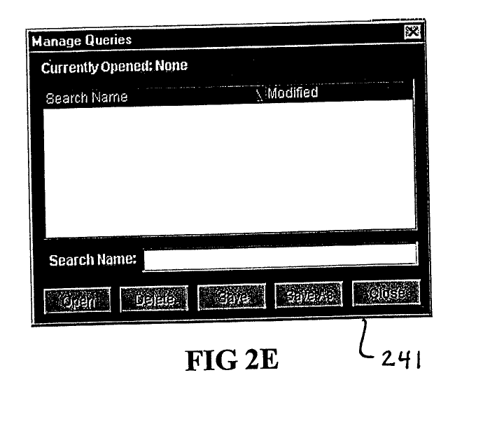

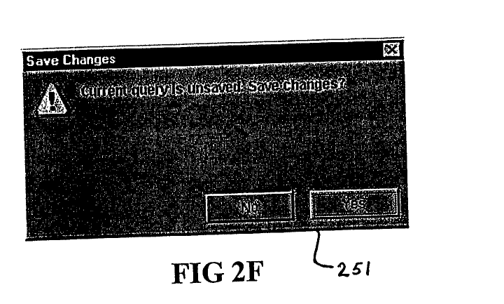

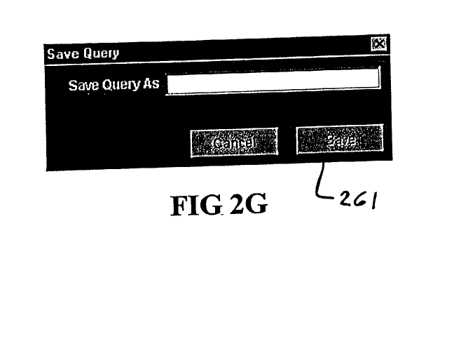

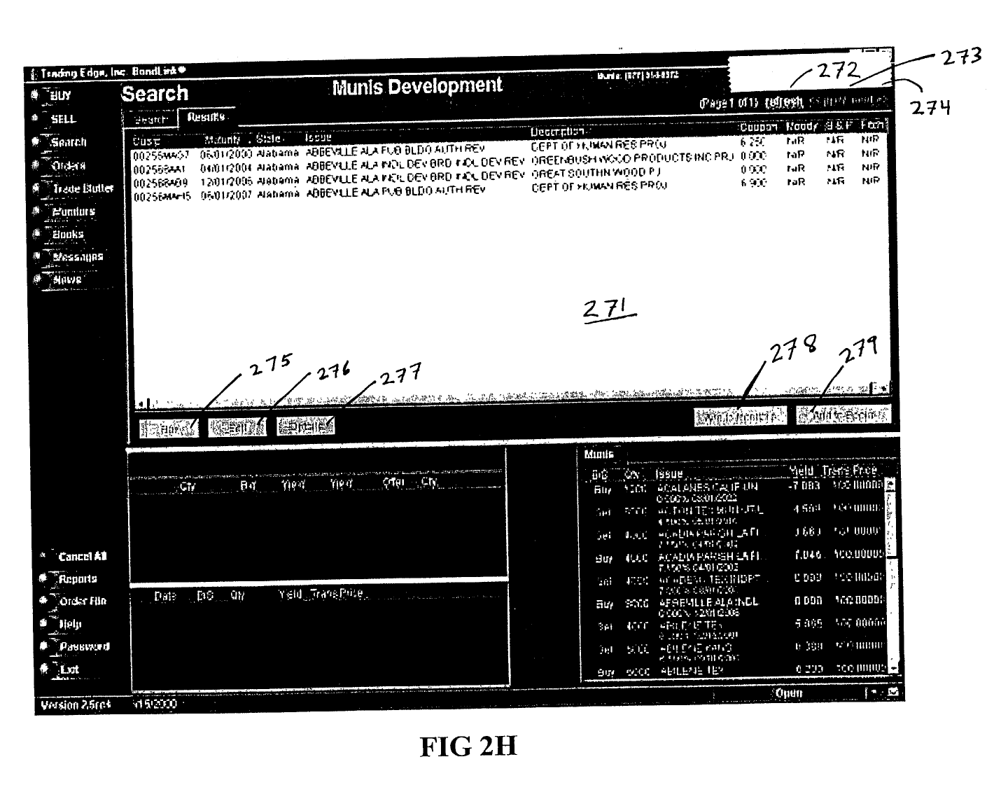

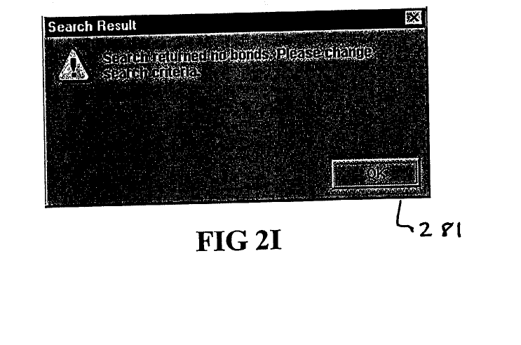

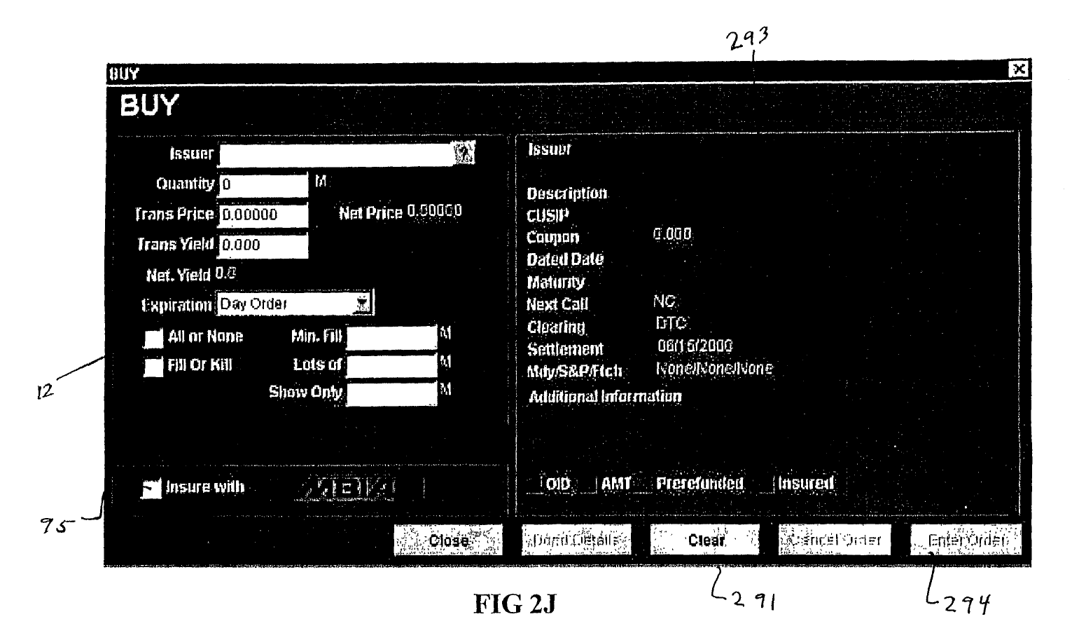

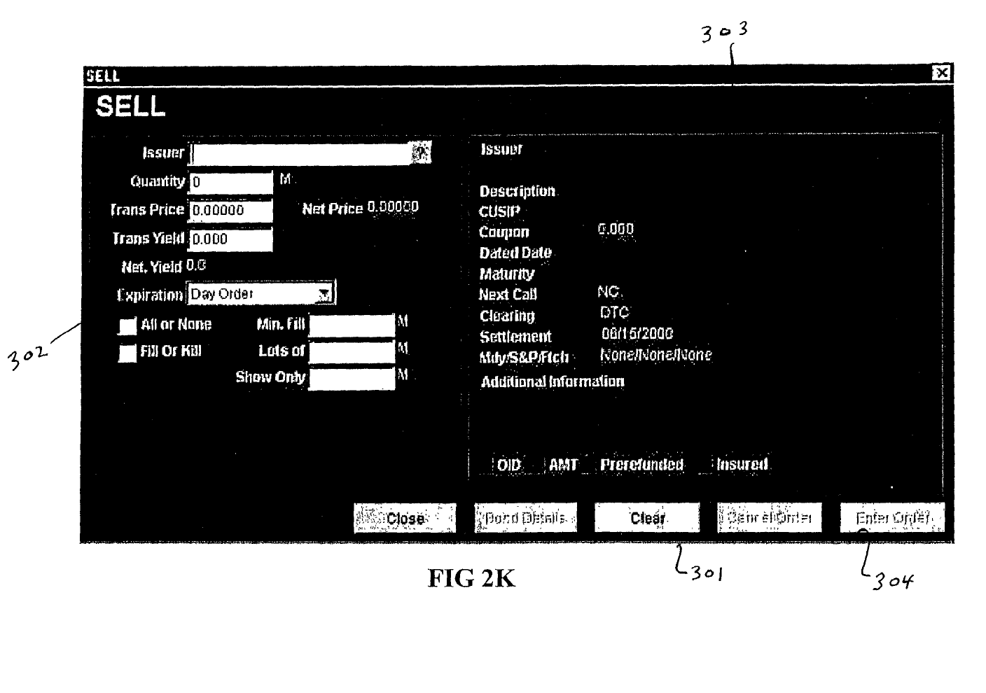

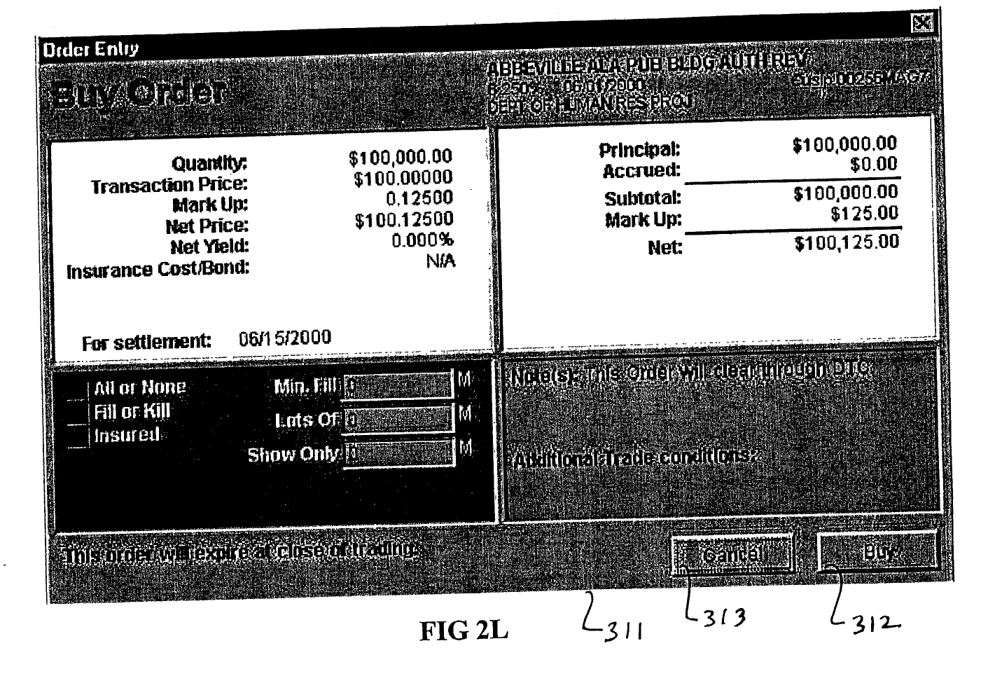

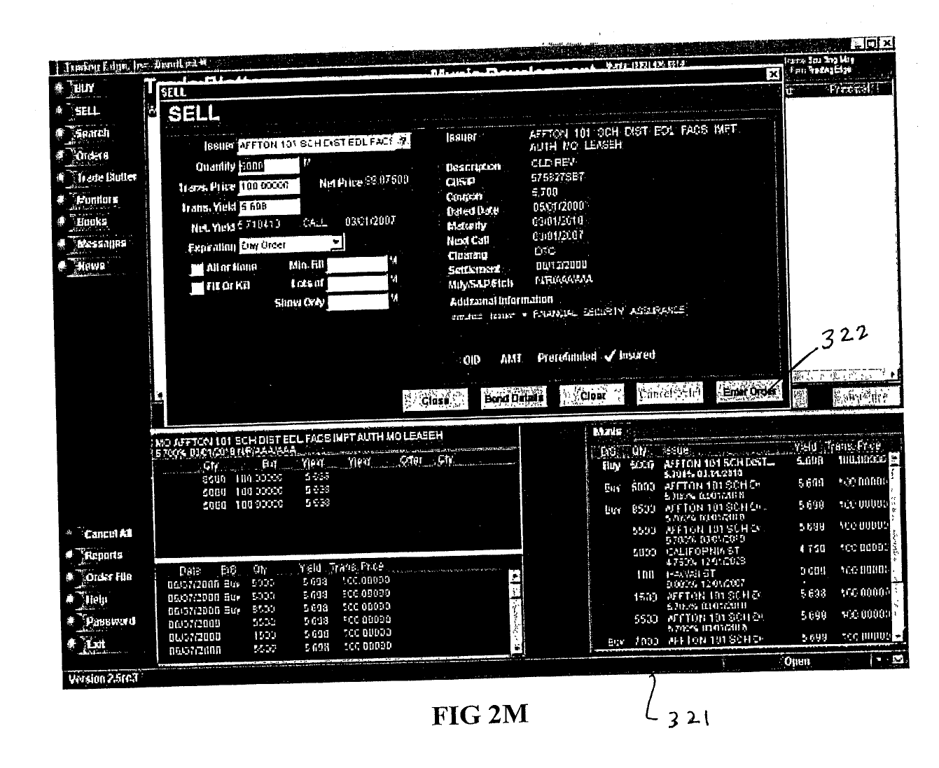

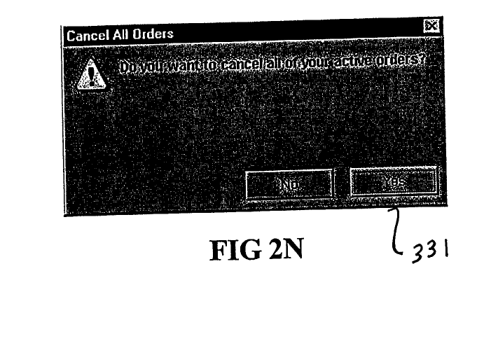

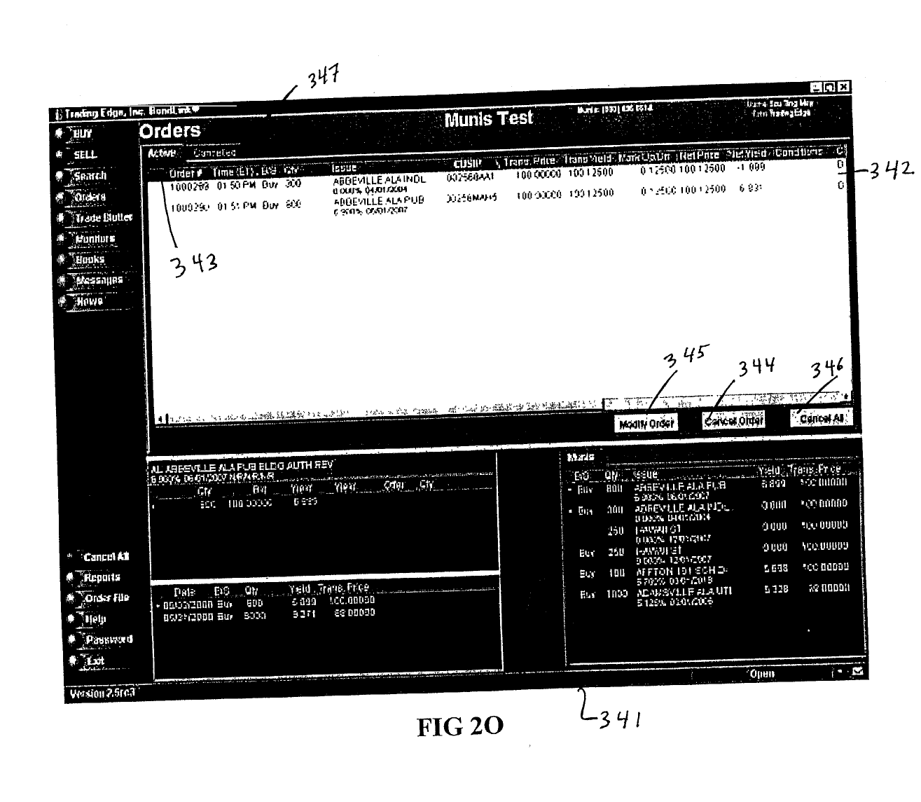

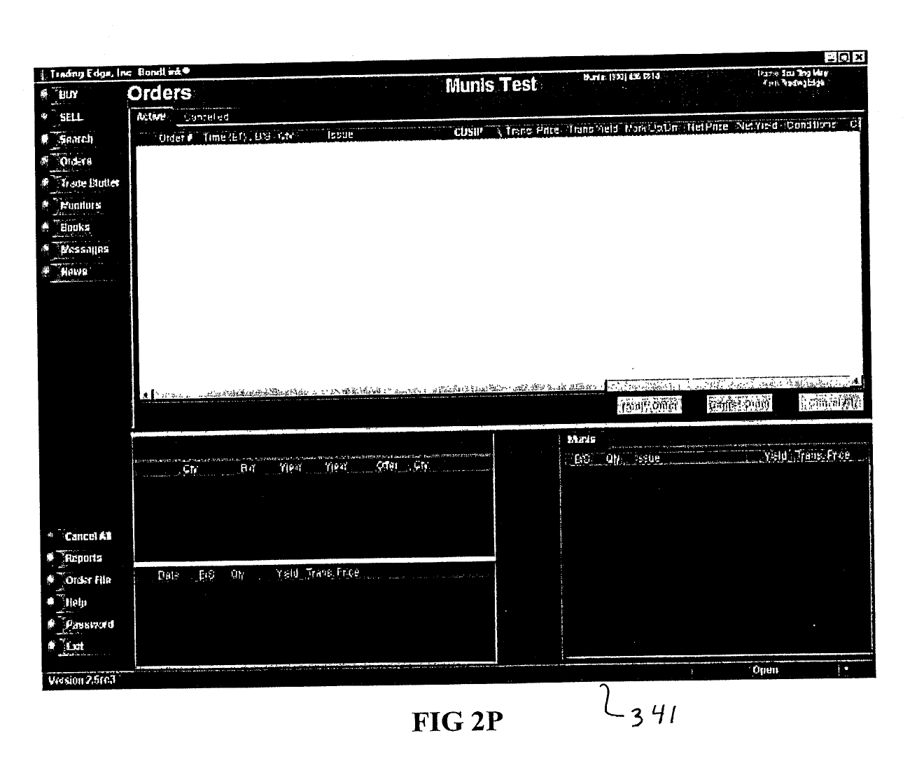

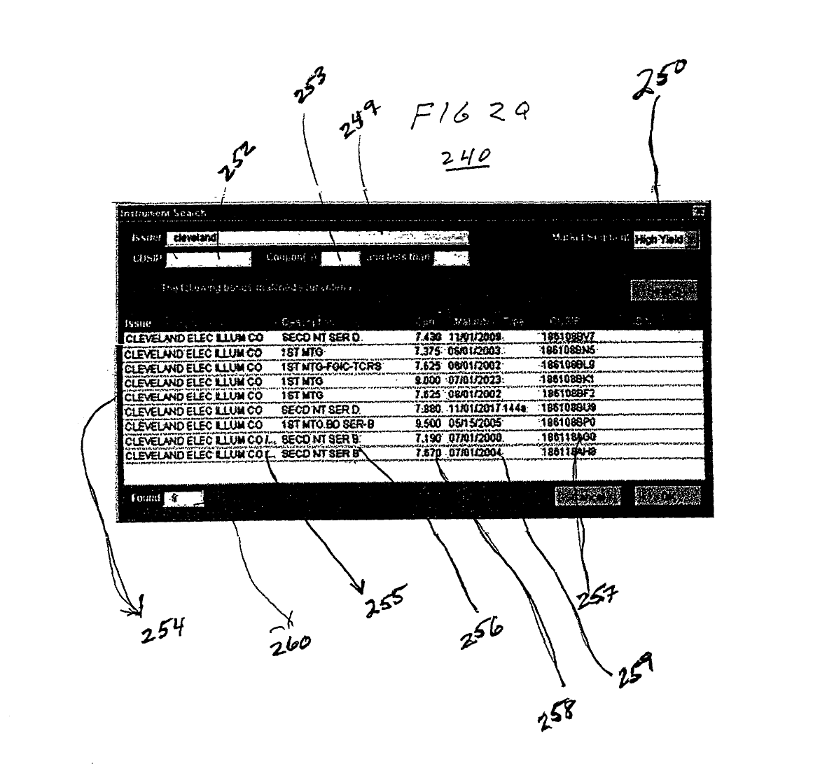

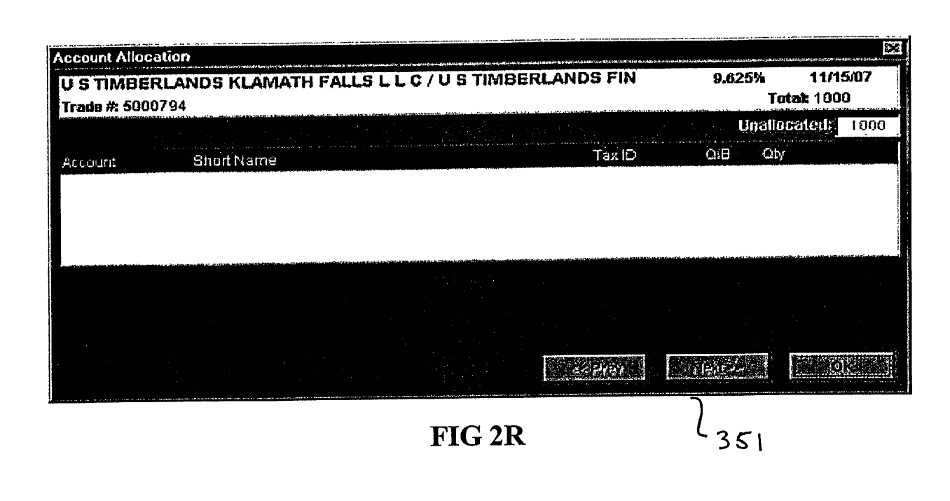

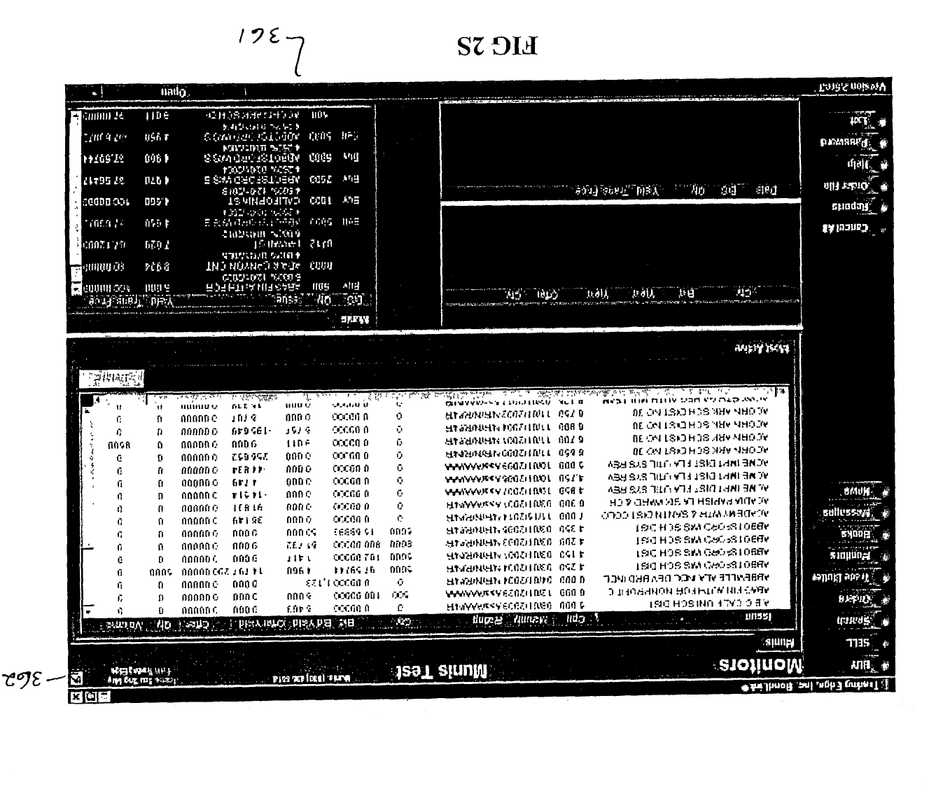

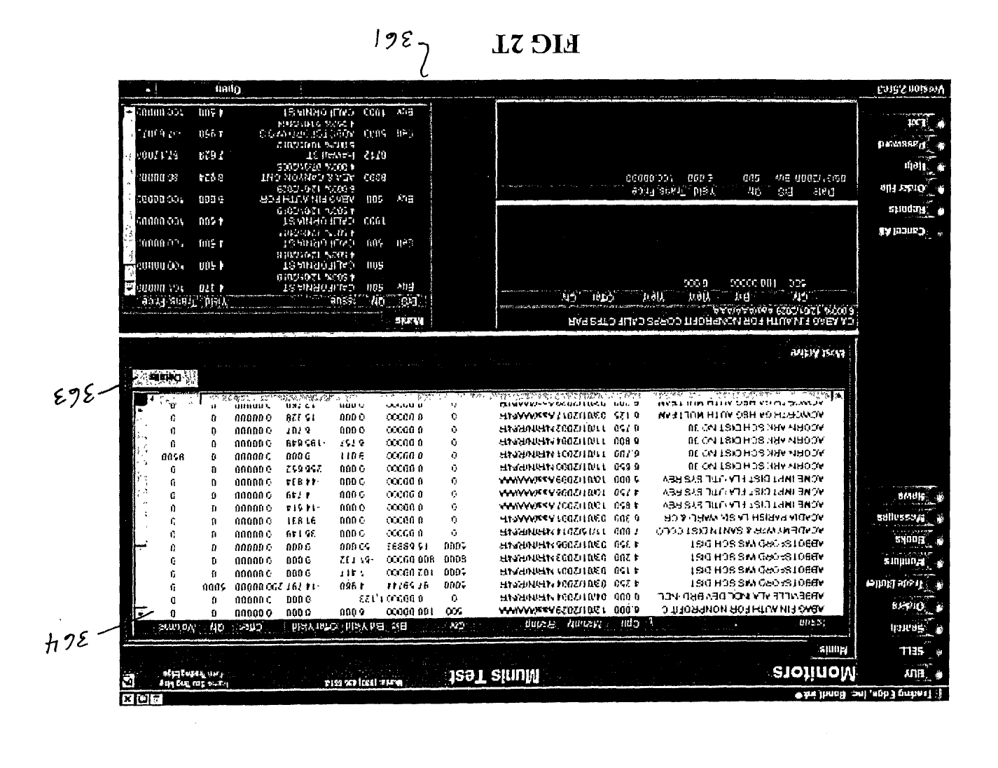

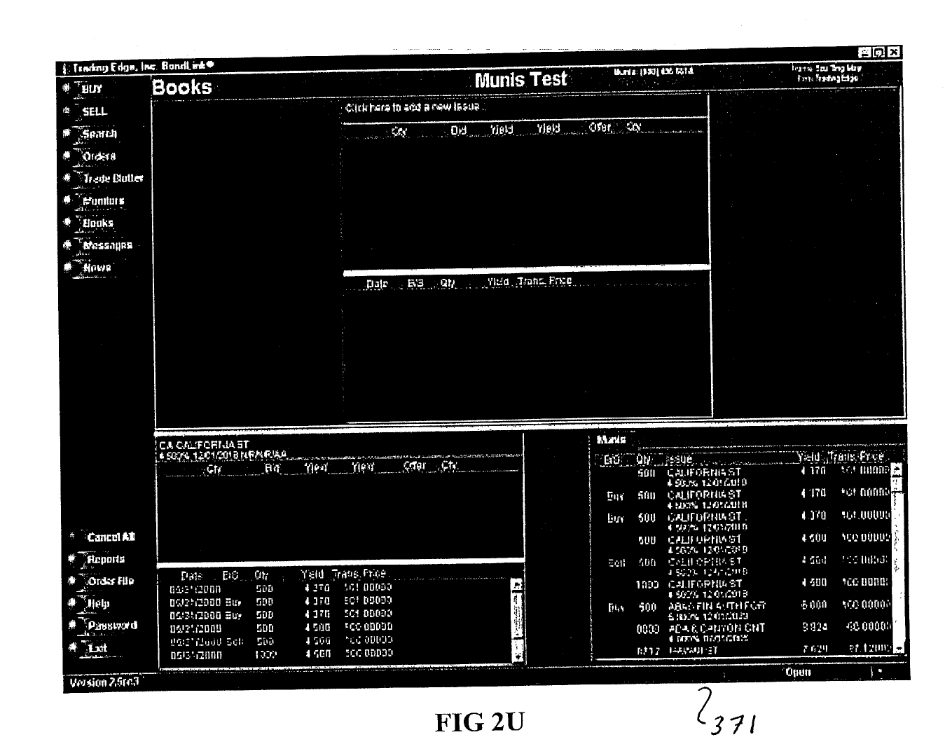

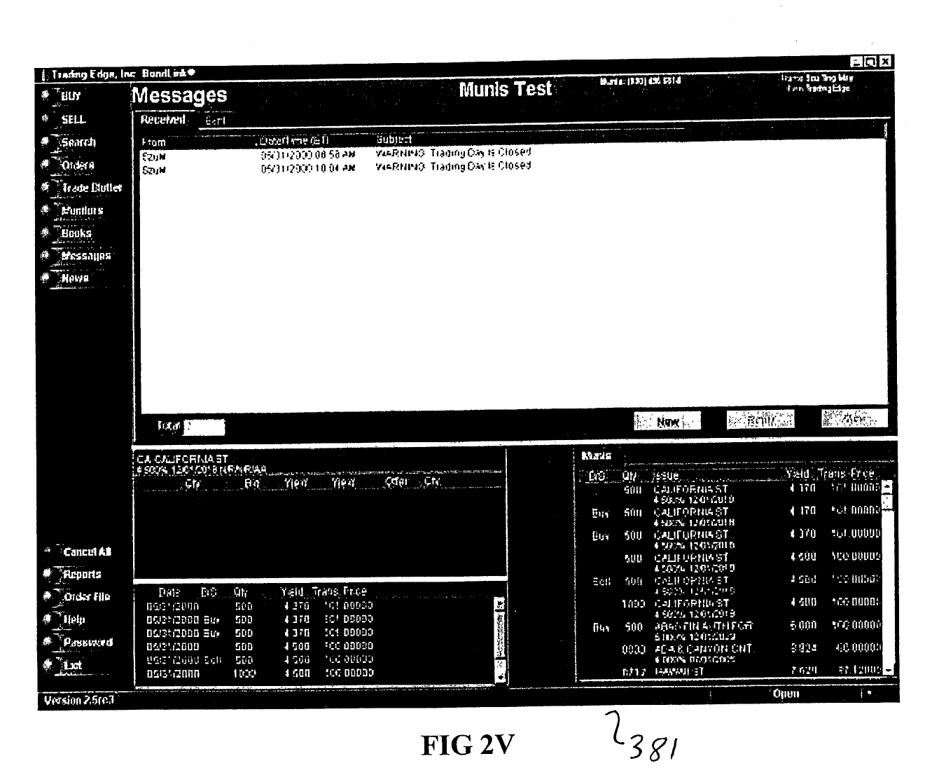

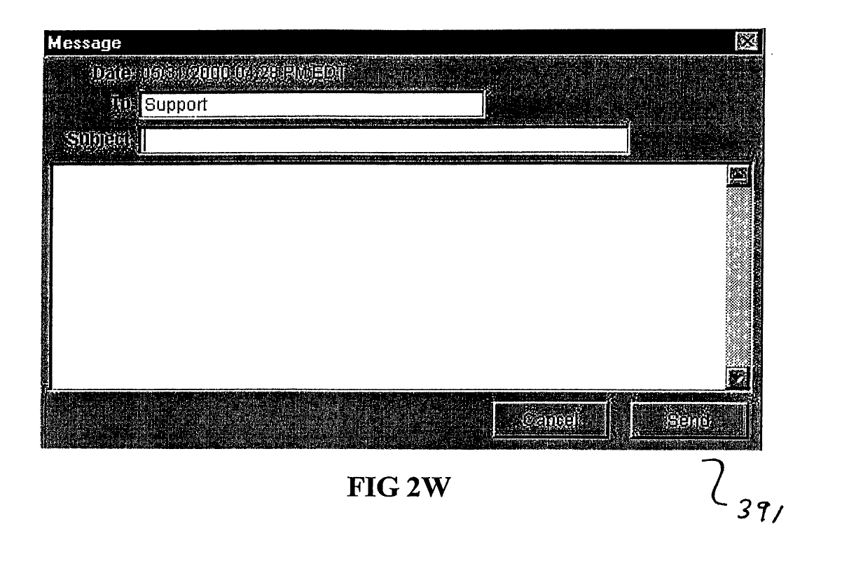

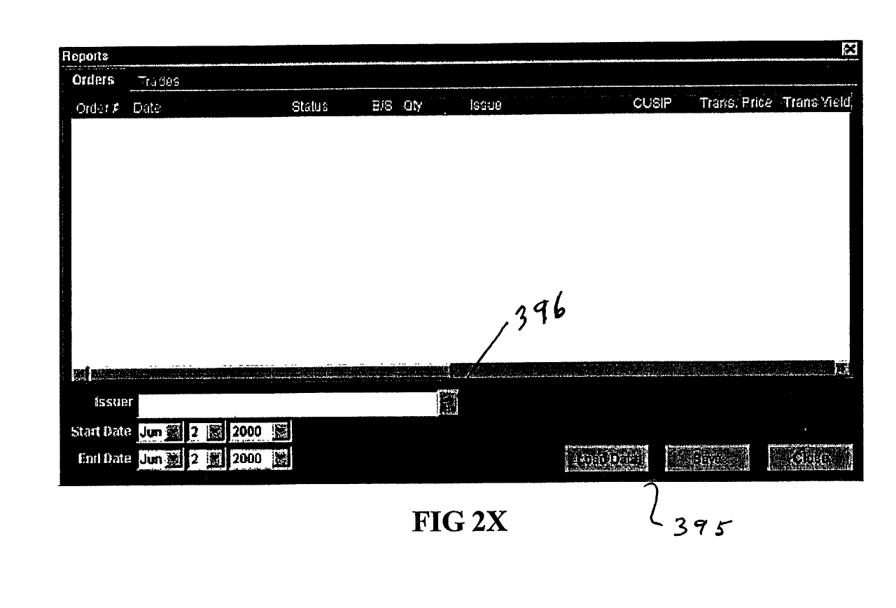

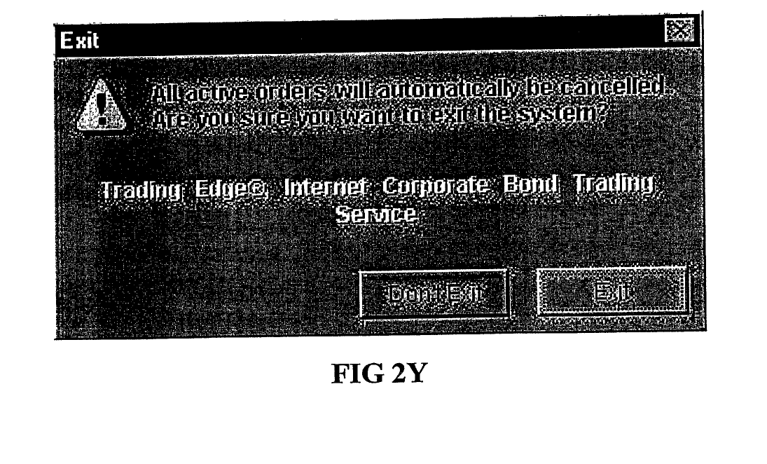

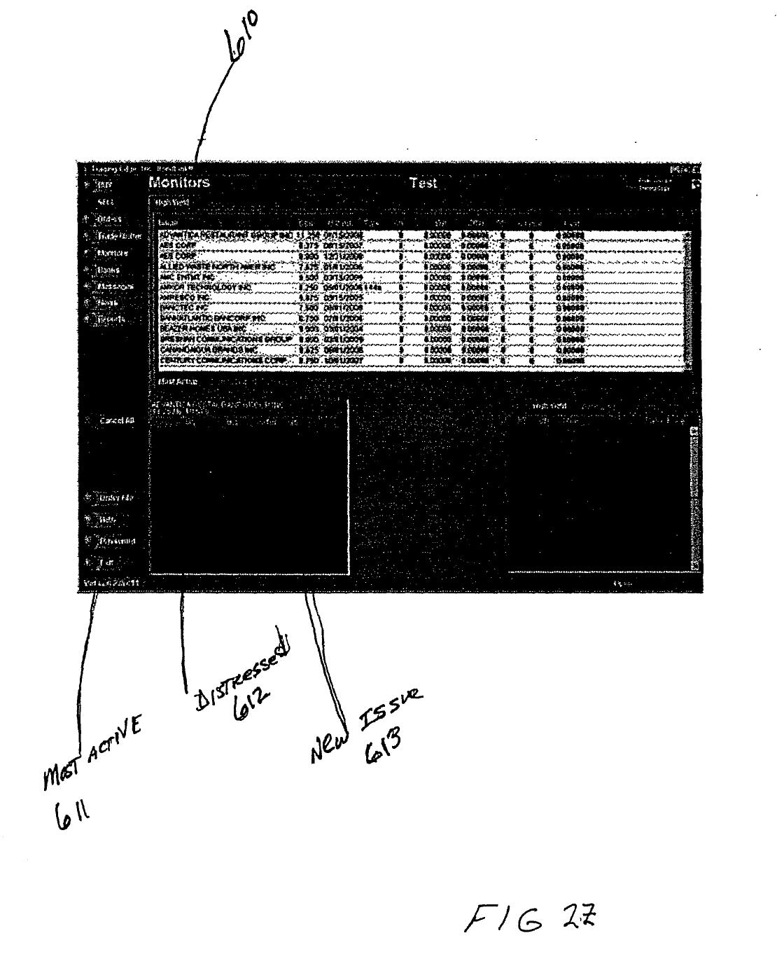

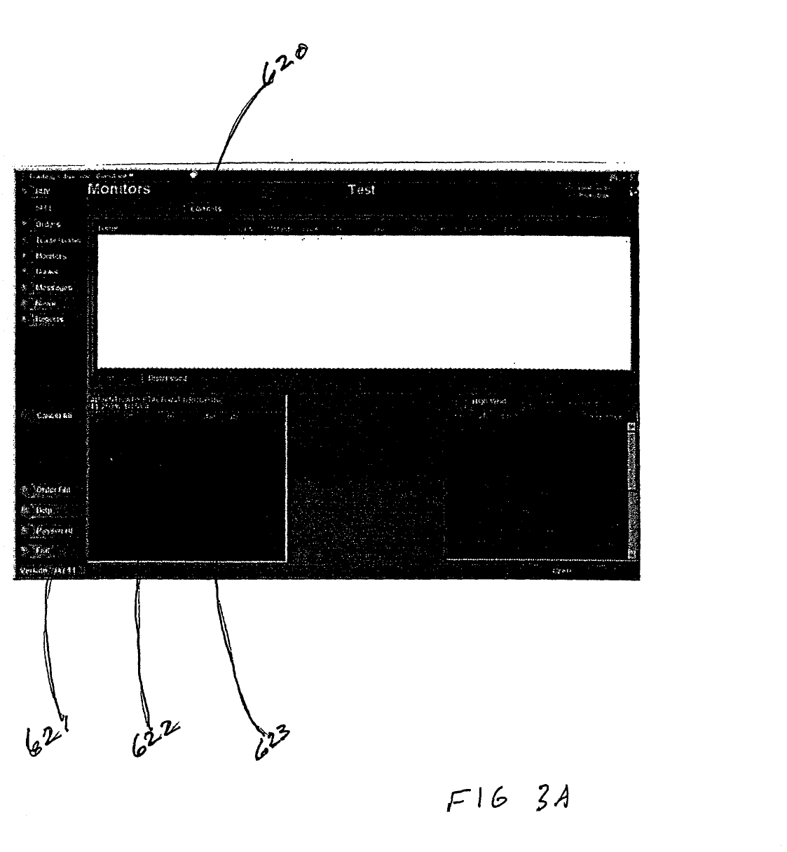

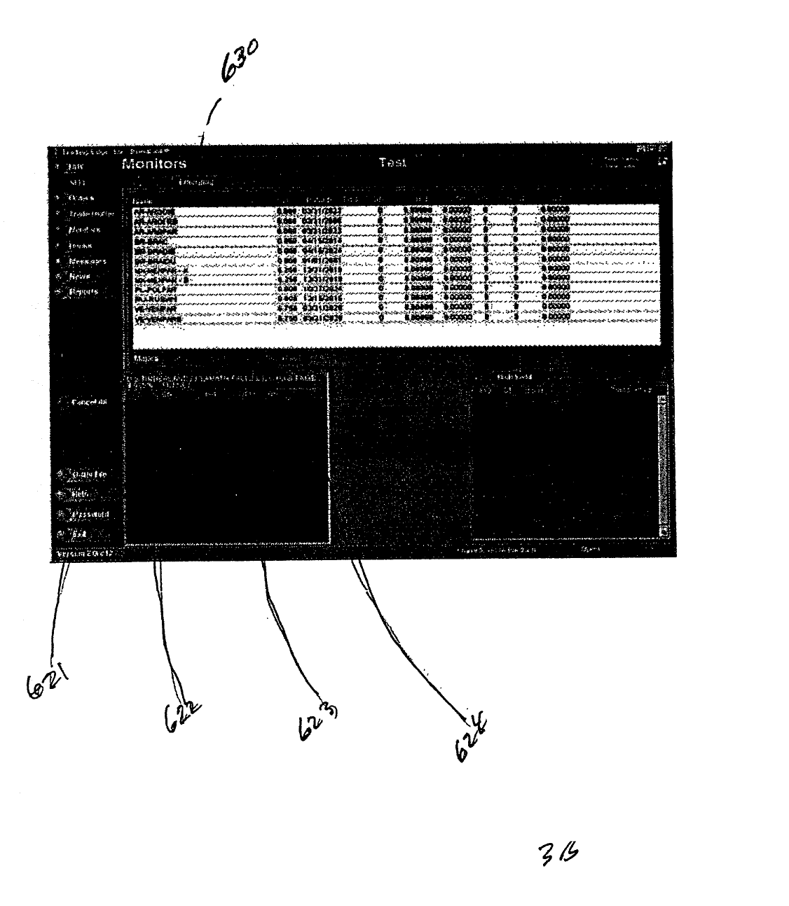

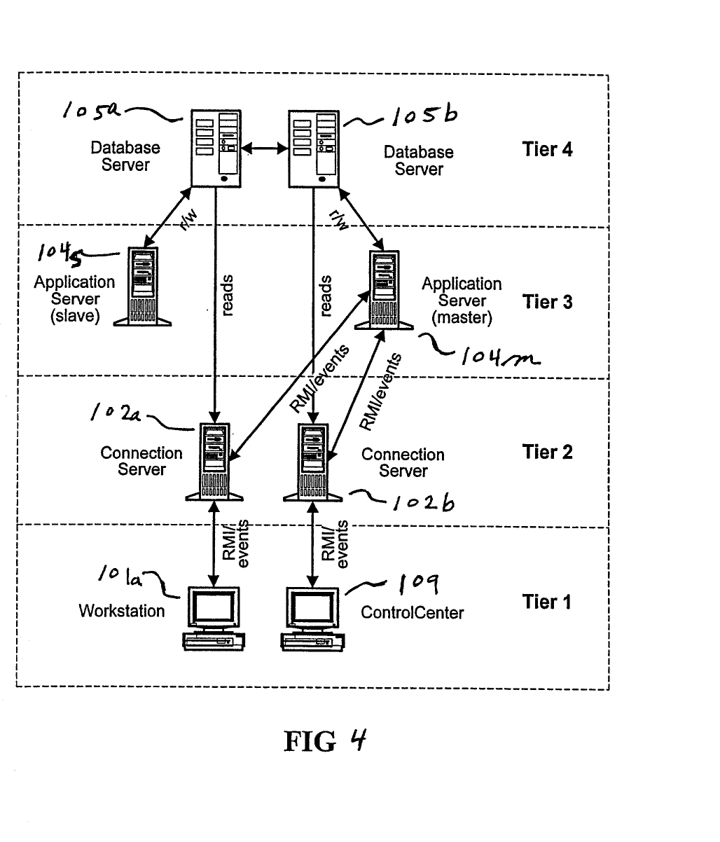

The client application includes a graphical user interface (GUI) that enables a user to quickly and easily view the market in a bond and to enter trading orders for all available bonds and bond markets. FIGS. 2A-Z depict various exemplary screens presented to the user as part of a graphical user interface according to one aspect of the present invention for use in municipal bond trading. Other embodiments of the invention for trading in other debt instruments (high yield, emerging markets, corporate, convertible, etc.) may incorporate a similar client GUI, which includes specific features related to those debt instruments. The general structure of the GUI, however, may remain the same. Alternatively, the same GUI may handle all debt instrument markets simultaneously by, for example, providing pull down tabs, one for each market. Navigating in the graphical user interface of the present invention utilizes typical Windows® conventions for both mouse and keyboard.

Logging into the bond trading system begins by clicking on the Start Menu (Windows 98), clicking on Programs, and selecting the main program folder name, e.g., “Trading Edge,” and clicking on the bond trading system application name, e.g., “BondLink.” Doing so brings up the screen 201 shown in FIG. 2A, which is the updater box 201. This process permits the BondLink service to download the current security master list and any enhancements to the service that have occurred since the last user login.

When this process is complete, the user clicks on the BondLink button 202 and the Login screen 203 (see FIG. 2B) appears. The user enters his user name, firm and password in the appropriate fields (204, 205 and 206, respectively) and clicks on the login button 207.

The BondLink service employs security devices on multiple levels. When a user is initially authorized to use the service, the user is assigned a password. The user is required to promptly change this password of the user's choice. After the initial login, the user is provided with the change password screen 210, which is shown in FIG. 2C. The user enters a new password in the new password field 211. The user confirms the new password in the confirm password field 212. Once these are entered, the user clicks on the OK button 213. The new password must have a minimum of six characters, including, at least, one number, which is checked by the system upon submission of the new password to the system. If the new password fails this determination, the user is returned to the change password screen 210 until the new password meets the system verification test.

Every sixty days, BondLink requires the user to create a new password. The user then has three more grace logins within which to install the new password. The same password cannot be used more than once in a three-month period. Each time a new password is required, the user is provided with the change password screen 210. If a user attempts to login with the wrong password three times in a row, the user will be locked out of the system. Once the user has successfully logged into BondLink, the service will display the Initialization Screen (not shown) while it initializes forms and synchronizes the data.

BondLink provides several levels of user permissioning. The permission level set for each user will determine what functions a user can perform. Users permissioning is set-up when the user is added to the BondLink service. The permissioning levels are grouped into the following categories of users: (1) Manager; (2) Trader; and (3) Trade Support.

The Manager Level of permissioning gives a user (manager or head trader) site-wide privileges to: (1) view orders (both active and cancelled) for assigned users across the site; (2) view trades for assigned users across the site; (3) cancel orders placed by assigned users at the site; (4) aggregate trades by assigned users in the trade blotter; and (5) perform all other activity that falls under the “Trader” permissioning level. The manager level user determines the number of users under the manager level user's “domain.” When a user is setup with the manager level permissioning, he will instruct Trading Edge to place specific users under his domain.

The Trader Level of permissioning gives a user privileges to: (1) view his own orders (both active and cancelled); (2) view his own trades; (3) modify his own orders; (4) cancel his own orders; (5) aggregate his own trades; (6) allocate his own trades; (7) create his own user specific monitor tabs; (8) perform all other activity, such as send messages, view books, monitors and news.

The Trade Support level of permissioning gives a user privileges to: (1) allocate transactions on behalf of traders; and (2) aggregate transactions on behalf of traders. A trade support user cannot perform any of the trading functions such as entering, modifying or canceling orders.

The number of users that a trade support user can be assigned to is determined by the trade support user's manager. When a user is setup for trade support permissioning his manager will instruct the system to assign the trade support user to traders.

Navigation in the graphical user interface of BondLink utilizes typical Windows conventions. For example, by holding the Control key you can highlight multiple selections, and, you can use arrow keys and scroll bars to scroll up or down a list. The user may either point and click with a mouse or move from field to field using the Tab key on the keyboard and complete an action by hitting the enter key. A combination of mouse and keyboard can also be used.

After the initialization screen (not shown), BondLink will automatically open into the Search window 214. The BondLink main screen 214 includes six distinct areas 217-222. The first area 217 (or navigation menu) lists the various screens that may be selected and opened by a user and which when opened appear in area two 222. The various screens that may be opened in area two 222 include: a buy screen, a sell screen, a search screen 224, an orders screen, a trade blotter screen, a monitors screen, a books screen, a messages screen, and a news screen. Each of these will be discussed in detail below.

The third area 218 lists the various commands that may be entered by a user: cancel all orders, reports, order file, help, password and exit.

The fourth area 219 lists the open orders for a given user. The fifth area lists the executed orders for the given user. This is the user's book.

The sixth area 221 is the scrolling ticker for all orders and trades in the system. There is a scrolling ticker for each of the markets—high yield, municipal bonds, emerging markets, convertibles, corporate, etc.

The Search window contains two tabs within it: Search 216 and Results 215. The Search tab 216 is the input area for your search criteria, the output of which is displayed in the results tab, which is opened upon clicking the search button 225. The Results tab 215 will display the results based on the entered search criteria. There is a search screen for each of the markets—high yield, municipal bonds, emerging markets, convertibles, corporate, etc.

A search input box 230 enables the user to select a query that the user had previously saved. If the user clicks on the entry box 230 or the drop down arrow 231 associated with the search input box, the user opens a pull-down menu that displays a list of saved queries. If the menu only displays <None>, then there are no saved queries.

To save a query, after receiving the results, the user clicks on the file button 229, a window 241 (see FIG. 2E) will appear enabling the user to save the query with a user-defined name.

The fields that may be input to the search engine include: previously saved searches 230, which are available from a drop down menu 231; an issuer 232; CUSIP 233; State 234 (which may be selected from a list); issuer type 235; and a purpose for the bond issue 236. An exclude button 237 may be selected to perform a search of all but the specified bonds.

In the box next to the Search Name 229, the user may enter a Search Name and click on Save to save a specific search.

In the issuer field 232, the user can enter a specific bond issuer into this entry box.

In the CUSIP field 233 the user can enter a specific CUSIP code into this entry box.

In the state field 234, the user can choose the state(s) from the scroll-down selection menu. To select a state, the user clicks on the state name. To deselect a state, the user clicks on the selected state a second time.

In the Issue Type field 235, the user can choose the type(s) of bonds from the selection of issue types. To select an issue type, the user clicks on the issue type. To deselect an issue type, the user clicks on the issue type a second time.

In the purpose field 236, the user can choose a specific purpose or a set of purposes from the selection in the scroll-down menu. To select a purpose, the user clicks on the purpose. To deselect a purpose, the user clicks on the purpose a second time. The Exclude button 237 will exclude any highlighted purposes from a search.

Additional search fields in box 226 provide the user the capability of performing more advanced searches, including range specific searches. Each field in box 226 has a minimum and maximum subfield that enables the user to specify a range of values used in the search.

In the Coupon field in box 226, the user can choose the range of the coupon percentage by entering coupon amounts into the Minimum and Maximum fields associated with the coupon field. For example, if a user wanted a coupon that is between 5.5% and 10%, then the user would enter 5.5 into the Minimum field and 10 into the Maximum field.

Using the Maturity field, a user can choose the range of the maturity of the bond by entering the maturity dates into the Minimum and Maximum fields.

Other fields in box 226 enable the user to specify bond ratings. The Moodys, S&P, and Fitch fields represent bond rating services and their associated ratings. A user can choose a range of different ratings from the pull-down menus associated with each of the three ratings services.

The user can specify a range of the quantity using the quantity field in box 226. This enables the user to enter the range of the quantity.

The user can specify the yield of the bond using the yield field in box 226.

The user can specify a price in the price field in box 226. Thus, the user can enter the range of the price. The fields Quantity, Yield, and Price in box 226 are only available if the Trans Type (transaction type) in area 227 is set to Buy or Sell. A user has three options for Transaction Type: Buy, Sell, and N/A.

If the user selects “Buy” from the Trans Type, the results will display a list of issues, in which Buy orders have been placed on the system and those Buy orders meet the other search criteria.

For example, if a user selects Alabama, enters a coupon range of 5.5% to 6%, and selects Buy as the Trans Type, the results will list all Buy orders that were placed in the system for Alabama with a coupon between 5.5% and 6%.

The user can select Buy or Sell, however, the user cannot select both in the same search.

Area 227 specifies a Bond Variety List. This enables the user to select three options for each of the bond varieties: Yes, No, and N/A. The bond varieties include: Insured, Pre-refunded, Callable, Bank Qualified, those that are subject to the alternative minimum tax (AMT), Escrowed, and Taxable.

There is an additional option 228 under the Trans Type that determines the number of results that will appear per page. The default setting is 10.

There are two buttons at the lower right corner of the window: Search 225 and Clear. Clicking on Search 225 generates a list of results based on the inputted search criteria. The results for the specified search are then displayed in the Results tab. If the user selected a Buy or Sell Transaction Type, then additional columns for Quantity, Yield, and Price will be included in the list.

Clicking on the Clear button sets all inputs to their default settings. If the user did not previously save his or her query, then pressing the Clear button will bring up a message window 251. This window will present the user with the option to save the search query, as shown in FIG. 2F.

If in window 251, the user selects YES, then window 261 (see FIG. 2G) will open enabling the user to save the query using a user specified name.

Turning to FIG. 2H, shown therein is an exemplary Results screen 271 for the exemplary query (State=Alabama, coupon range of 0% to 7%, Trans Type=Buy). Submitting the query switches the screen to the Results tab. The results are displayed in order of Maturity, then Issue. There are display columns for CUSIP, Maturity, State, Issue, Description, Coupon, Moody rating, S&P rating, and Fitch rating.

If the search engine does not find any results, then a message window 281 (see FIG. 2I) will appear to inform the user to change the search criteria.

On the top right corner, there is a refresh option 272, a previous option 273, and a next option 274. Clicking on the Refresh 272 button causes the search engine to perform the search again. Clicking on previous 273 and next 274 options will only be available if the search returns more bonds than can fit on one results page. Previous 273 takes the user back one page, whereas next 274 takes the user forward one page.

In the Results screen, the user selects the bond that the user wants by clicking within that row of information. When that issue becomes highlighted, the five buttons located on the bottom of the window will become available: Buy 275, Sell 276, Details 277, Add to Monitors 278 and Add to Books 279. Clicking on the Buy button 275 brings the user to the Buy order screen (see FIG. 2J). Clicking on the Sell button 276 brings the user to the Sell order screen (see FIG. 2K). Clicking on the Details button 277 displays detailed information about the issue. Clicking on the Add to Monitors button 278 adds the selected issue(s) to the Monitors form (see FIG. 2S). Clicking on the Add to Books button 279 adds your selected issue(s) to the Books form (see FIG. 2U). Highlighting multiple issues in the results screen, makes only the “Add to Monitors” and “Add to Books” buttons 278, 279 available.

A scrolling ticker window 221 appears in the lower right quadrant of every screen. There is a scrolling ticker for each of the market segments—high yield, municipal bonds, emerging markets, convertibles, corporate, etc. It displays three types of information: all BUY orders as they are received by the service, displayed in green; all SELL orders as they are received by the service, displayed in red; and all transactions as they are executed by the service, displayed in blue. All of a user's orders (Buy or Sell) and any trade in which the user is involved are displayed with a “+” indicator. If an order is executed immediately after it is entered, only the executed trade will be displayed in blue. If a user entered a “Fill or Kill” order that does not execute, it will not be displayed in the ticker but will appear in the Cancelled orders tab in the Orders form.

The status bar 238 appears across the bottom of every screen. It can be used by the system to send any urgent messages to a user. The message will scroll along the bottom of the status bar. The status bar displays system status, “Open” or “Closed,” depending on whether the service is open for trading. Trading hours are from 7:30 am-5:00 pm Eastern Time. A flashing envelope indicates that a user has unread messages from the system. Double-clicking on the envelope or clicking the “Messages” button from the main menu 217 enables a user to read the message(s) (see FIG. 2V).

The book window 220 appears in the lower left quadrant of every screen. It displays all bids, offers and quantity for the highlighted security in price/time priority. All of a user's orders will be displayed with a “+” indicator next to the order.

Placing New Orders is possible in several ways. Buy/Sell Tickets can be invoked by any one of the four following methods. First, clicking on the “Buy” or “Sell” button from the navigation bar 217 will invoke the appropriate buy or sell order ticket.

Second, double clicking on an active bid/offer in the monitor (see FIG. 2S), invokes the appropriate contra ticket. However, if the bid/offer is zero then the appropriate ticket is invoked for a user to put a bid/offer for that instrument. As an example, if the offer is zero, and a user double clicks the offer side, the user will invoke a sell ticket. However, if an offer was already active and the user double clicks the offer side to invoke a ticket, the user will get the green Buy ticket to act on the bid. Only one active ticket is allowed at any one time. Once the ticket is executed, the dialog window box must disappear before an execution may occur and you will return to the monitor screen. To enter an offer on an issue already showing an offer, a user employs the “Sell” button located at the main menu.

Third, single clicking on the scrolling ticker 221 will display the instrument book; double clicking will invoke a contra Buy/Sell ticket (see FIG. 2M).

Fourth, double clicking on an order in the Book will invoke a contra Buy/Sell ticket (see FIG. 2M).

By invoking any one of the four methods described above the user brings up the form 291, 301 (see FIGS. 2J—Buy—and 2K—sell) for the type of order he wishes to place. Referring to FIGS. 2J and 2K, the information on the left half of the order form 292, 302 displays information about the specific order. The information on the right side of the form 293, 303 is specific to the Issue selected.

To enter the order, the user must fill in the following fields: Issuer, Quantity and Transaction Price or Transaction yield. In addition to these mandatory fields, the user may choose to put a time limit on the order, or other trade conditions. This information is described below.

Issuer

If a user clicks on an order from the book, monitor or ticker, the issuer field and all information about that CUSIP will be populated. If the user selects a buy or sell order form from the navigation bar, the issuer fielded will be blank. The user may select an issuer by performing a search on the database, as described above.

Quantity

Quantity refers to the number of bonds to buy or sell. Example: If a user enters 1000 in the quantity field, the user is entering 1,000 bonds, which is the equivalent of $1,000,000 face amount (1,000×$1,000=$1,000,000).

Transaction Price

Transaction price is expressed in dollar amounts as a percentage of par up to five decimal places. The Transaction Price is the price before a markup/markdown is applied. This price is represented with the order in the Scrolling Ticker and Book.

Net Price

The net price equals the transaction price net of the markup/markdown. It is the actual price (as a percentage of par) at which settlement monies will be calculated. This field is displays “0.00000” until a transaction price or transaction yield is entered.

Transaction Yield

Transaction yield is the yield based off of the transaction price. This yield is displayed with the order in the Scrolling Ticker and Book. Alternatively, a user may enter the transaction yield at which the user wishes to transact and the system will calculate the transaction price.

Net Yield

Net yield represents the yield of the security after application of the markup/markdown. It will automatically display when price is entered and upon clicking or tabbing to another field. This field is grayed out until a transaction price or transaction yield is entered

Expiration

Expiration refers to the limited time during which an order will be considered executable. There are three choices: (1) Day Order—order is executable for the duration of that particular trading day; (2) Good For—order is executable for a specified period of time, expressed in hours and minutes; and (3) Good Until—order is executable until a specified time of day.

Trade Conventions

Most trade conventions are user-defined, with the exception of those displayed as “Additional Trade Conditions.” As all orders in are executed on a price/time priority, adding trading conventions to an order will affect its priority for execution on the system. Using the convention “All or None” means that the order must be completed in its entirety or it will not be executed. Employing the convention “Fill or Kill” means that the order must be immediately filled in its entirety or cancelled from the system. In these cases, the trader entering an order with these conventions will not see his order in the scrolling ticker. However, an execution will be displayed if applicable. If the order does not execute, it will be displayed in the Cancelled tab in the Orders form.

The convention “Minimum Fill” specifies the minimum amount that must be executed if the quantity is less than the full amount.

“Lots Of” specifies the quantity increments by which the order may be filled. This number must be evenly divisible by “Show Only” quantity and “Minimum Fill” quantity.

“Show Only” instructs the system as to the portion of the total quantity that may be displayed to other users at any one time. The Show Only quantity will have price/time priority for only the amount shown. Amounts held in reserve will not have a price/time priority until shown.

When the user has entered information in all the required fields and specified any conditions to make the order subject to, clicking on the enter order button 294, 304 submits the order to the system.

According to one aspect of the present invention, a user may simultaneously submit a buy order to the system and purchase insurance for that bond. To do so, the user selects the “Insure With” button 295. In this exemplary embodiment, only one insurer is provided, however, multiple vendors for this insurance are possible. In fact, the user could request insurance quotes from many providers and select the optimum insurance based on price or other factors. In this case, the “insure with” button 295 may include a drop down menu of insurance providers and selecting one requests a quote from that provider. Selecting multiple or all requests quotes from the selected providers. Moreover, the requester may preselect the providers based on other non-cost factors and then provide the system with the authority to bind his order to the lowest received costs, thereby providing a competitive real-time market in bond insurance that heretofore was not possible.

Insurance is only available when entering a Buy order. If a user wants to purchase the bond and insure it, then the user clicks on the box 295. Upon entering the order, the system will retrieve an insurance quote from the listed vendor or vendors, such as MBIA. The order confirmation window will include the cost of insurance and the new net price and net yield.

The right side of the screen displays information about the selected security. This information is obtained from a provider of bond data, such as J J Kenny.

When the user has finished entering in the order information and clicks on the enter order button 294, 304 the Order Confirmation dialog box 311 (see FIG. 2L) will appear. The order entry confirmation dialogue box 311 will appear after selecting the “Enter Order” or “Modify order” button from the buy or sell order form. The Order Entry dialog box displays information about the security, quantity, price, net yield (net of markup/markdown), trading conditions and settlement date. In addition, the box displays the total dollars, accrued interest (if applicable), markup/markdown in dollars, total insurance cost (if applicable), and net dollars for settlement. This enables the user to review all the information to ensure that he has properly entered the terms and conditions for the trade. The dialog box 311 shown in FIG. 2L is for a buy confirmation order. If the user has requested insurance, then the net price, the net yield, and all settlement monies will include the cost of the insurance.

If the dialog box displays the order the user wishes to enter, pressing the Buy/Sell button 312 (buy only) transmits the order to the Trading Edge host, places the order into the Book for the security and broadcasts the order, in accordance with its terms, to every user's screen. If the user wants to cancel or change any of the information about the order, the user can select “Cancel” and he will be returned to the buy or sell order form 311.

A user may trade a bond by reacting to an Existing Order listed in the scrolling ticker, for example. The scrolling ticker lists all orders that are broadcast to all users. If a user wants to react to an order in the scrolling ticker, the user places the mouse pointer over the order. The color will brighten to confirm that the cursor is properly placed. Clicking the left mouse button. The system will display the ticket representing the opposite transaction type 321, as shown in FIG. 2M.

Order information will default in the Issuer, Quantity, Price and Yield fields, as will information from the security master list. If the user desires to enter the order as is, the user clicks the Enter Order button 322, reviews the Buy/Sell Order Entry dialog box (not shown but similar to that in FIG. 2L, but for a sell order), and—if the terms are correct—clicks the Buy/Sell button (e.g., 312 of FIG. 2L).

The book will broadcast to all users active orders for a given instrument, in the order received by the host by Price/Time priority. Orders are displayed in the Book in price/time priority. If a user wants to react to an order that appears in the Book, he places the cursor over the order. The color will brighten to confirm that the cursor is properly placed. Then, upon clicking the left mouse button the system will display the order form for the contra side of the highlighted order.

Another way to enter an order is as follows. If a user is a buyer and there are a number of orders in the Book on the offer side, the user may select any order in the Book that represents the highest quantity he is willing to purchase. This will facilitate his ability to “sweep” the Book for the aggregated volume at the various prices. The Buy order form will be filled in with the total quantity up to and including the order he has selected, and the price of that order. If the user enters his order, the trades will execute at the various prices of each resting order up to (in the case of sell orders) the highest price he has selected. This feature also works in the case of a seller reacting to multiple buy orders.

Orders may be modified or cancelled at any time. Users can only modify or cancel orders they have entered into the system. To modify/cancel an order, the user places the cursor over the order in the scrolling ticker and clicks. Alternatively, the user may place the cursor over the order in the Book and click. Yet another way, the user may click on the Order Blotter button in the navigation menu 217, which brings up the screen 341 in FIG. 20.

Referring to FIG. 20, the user selects the desired active order in the active orders tab 343 and clicks. To cancel the order, the user simply clicks on the Cancel Order button 344. To modify the order, the user makes any changes and clicks on the Modify Order button 345. Modifying an order may alter its priority in the Book.

To cancel all live orders, the user clicks on the Cancel All button in the left hand column, which brings up the screen 331 in FIG. 2N. The user may also click on the Order Blotter button, and from the Active Orders tab 343, select Cancel All 346 to bring up the screen 331. When this dialog box appears 331, clicking on “Yes” will confirm cancellation of all orders. All of the user's orders will be cancelled when this instruction is received by the host. These orders will no longer be executable.

Turning to FIG. 20, the Order Blotter screen 341 displays the user's entire active and cancelled orders. There may be an order blotter for each of the market segments—high yield, municipal bonds, emerging markets, convertibles, corporate, etc. The Order Blotter screen 341 also allows users to modify and cancel their own orders, and the orders of their managed users. The following order information is displayed in the Order Blotter: Order Number, Time, Buy/Sell, Quantity, Issue, CUSIP, Transaction Price, Transaction Yield, Mark Up/Down, Net Price, Net Yield, Conditions, Clearing, Market, Insurance Cost, Firm, Name. The Order Blotter screen 341 includes an Active tab 343 and a cancelled tab 347.

The Active tab 343 displays all of a user's open orders. Orders may be displayed in ascending or descending order by double-clicking on the column headings. To display the orders in ascending order, the user double-clicks once and to display the orders in descending order, the user double-clicks twice. An arrow on the right edge of the column heading indicates that the Order Blotter is being sorted by the selected column. If the arrow is pointing up orders are displayed in ascending order. If the arrow is pointing down orders are displayed in descending order. Further Information about each order may be found by scrolling right, using the scroll bar at the bottom of the blotter.

In the Order Blotter screen 341, to modify or cancel an order, the user highlight the order using his mouse. The order will be highlighted in yellow and the Modify Order and Cancel Order buttons will become active. Clicking on the Modify Order button will bring up the order form with the order information fields populated. At this screen, the user inputs any changes to the order and clicks the Modify Order button on the order form to confirm his changes.

Highlighting an order and clicking on the Cancel Order button will cancel the selected order. Managers may modify and cancel the orders of their managed users by using the same steps as described above. Clicking on the Cancel All button will cancel all orders for the user. Managers who click on this button will cancel all orders for all of their managed users, as shown in FIG. 2P, which is the order blotter screen 341 without any orders because they have all been cancelled by the manager.

The day's cancelled orders will be displayed in the Cancelled tab 347 at the start of the next trading day. By highlighting the desired orders and clicking on Re-enter, a user can reactivate these orders. Cancelled orders can also be modified and then re-entered.

The Trade Blotter (accessed by clicking on the trade blotter button in the navigation menu 217, FIG. 2D) contains all of the user's trades for the current trading day. There may be a trade blotter for each of the market segments. The trade blotter also allows users to average price and allocate trades for their own account or for their managed users. The following trade information is displayed in the Trade Blotter: Average, trade number, Time, Buy/Sell indicator, Issue, CUSIP, Quantity, Transaction Price, Transaction Yield, Mark Up/Down, Net Price, Net Yield, Allocated, Principal, Accrued, Net, Settlement, Insurance Policy, Insurance Cost, Enhanced CUSIP, Firm, Name and Average Pricing Trades.

The average price function allows users to combine multiple trades of the same security, side and user into one trade. This dollar weighted averaged trade may then be allocated across one or several accounts. Each account will receive the same price.

To average price two or more trades, the user selects the trades in the Trade Blotter and click on the Average Price button. A dialog box will pop up, displaying the trades and their average price as calculated by the system. To accept the average price, the user clicks on the “Yes” button at the bottom of the dialogue box, and then the trades will be combined into one trade. The Trade Blotter will display the new average priced trade. A “+” sign will be displayed in the Averaged column. To view the individual trades that comprise the average priced trade, the user places the cursor on the “+” and clicks the left mouse button. To close the breakdown of the average priced trade, the user clicks on the “−” in the Averaged column.

Once the trades have been average priced, this action cannot be reversed. Average priced trades will be reported for clearing at the average price. Bonds that are insured in the system cannot be average priced. If a user attempts to use the average price feature for bonds insured in the system then he will receive an error message.

Trades in the BondLink system may be allocated to several accounts. For users with only one account, the system will default all trades to that account. Users may view the allocation status of their own trades as well as the trades of their managed users in the Trade Blotter. Managers may allocate the trades of their managed users, if so permissioned.

To allocate one or more transactions, the user highlights the execution(s) and clicks on the “Allocate” button. A dialog box 351 (FIG. 2R) will pop up. This dialogue box 351 displays all accounts into which one may allocate the trade(s). The user enters the quantity he wishes to allocate to each account into the quantity field. As trades are allocated, the unallocated quantity is reduced. When finished allocating the trade(s), the user clicks on the “OK” button in the dialogue box 351.

Trades may be partially allocated throughout the day. The word “Partially” will be displayed in the Allocated column of the Trade Blotter if the trade is partially allocated. In order to find trades that have not yet been completely allocated, the user double-clicks on the Allocated column heading of the Trade Blotter. This will sort trades in the Trade blotter by their allocation status—fully allocated, partially allocated, or unallocated. Trades must be fully allocated within 45 minutes after the system closes for the trading day.

Managers may allocate trades for their managed users. If a Manager has a sub account associated with his user profile, and the managed user does not, the Manager may allocate the trade to his own sub account, provided that the Manager has already done a trade for his own account earlier that day. To select trades that are listed sequentially, the user presses the Shift key and highlights the trades he wishes to select, with the mouse. To select trades that are not listed sequentially, the user presses the Ctrl key and highlights the trades he wishes to select, with the mouse.

Turning to FIG. 2S, shown therein is the monitors screen 361. There may be a monitors screen for each of the market segments—high yield, municipal bonds, emerging markets, convertibles, corporate, etc. The monitor display provides users with a high level view of the system activity. Information such as best bid price and corresponding quantity, best offer price and corresponding quantity, trading volume, and last traded price are displayed by instrument.

The bids and offers in the system may be displayed using the Monitors display. The bid/offer columns will be highlighted to reflect price changes and trades in the system. Each time a new best bid or offer comes into the system, the monitor display will update as follows: Red—a down tick, and impacting best bid or offer; Green—an up tick, and impacting best bid or offer; Yellow—a Quantity change, with no impact to “best” bid/offer. Other colors may be used to make the difference noticeable to a user.

The user may access and manage Monitor Displays. Monitor screens can be accessed by clicking the “Monitors” button located in the navigation menu 217 (FIG. 2D) on the left side of the screen. When the “Monitors” button is activated, the monitor display will appear in the top half of the screen.

The monitor features a floating, detachable and sizable window. This increases the number of assets visible and allows for free positioning and sizing on the monitor. A user can activate the detachable feature by clicking on the icon 362 at the upper right hand corner of the monitor screen. Once the Monitor is detached, the user may re-size or move the monitor to another part of the screen. If the user moves the monitor, he is able to bring up another display, such as books, trade or order blotter. This allows the user to view multiple screens at the same time.

All of the monitor pages allow a user to highlight and click on any issue and the system will display the Book and the appropriate Buy/Sell order form. Orders can then be entered or cancelled.

FIG. 2U shows the effect of highlighting an order in the monitors screen. The top order 364 is highlighted, thereby activating the details button 363, which can be clicked to provide details regarding the selected order.

Monitor functionality allows users to create additional tabs other than those provided by the system. Personalized monitor tabs give users the ability to segregate and display securities as appropriate and most beneficial to the user.

To create a new monitor tab the user:

1. Clicks the “Monitors” button located on the left side of the screen 361.

2. Using the mouse, places the arrow to the right of the last market segment tab. In this case, places the mouse to the right of the “Munis” tab.

3. Right clicks on the mouse.

4. The “Add User Tab” button will be displayed.

5. Clicks on the “Add User Tab” button.

6. The “Add New Monitor Tab” window will be displayed.

7. Types in the name of the new tab in the “tab name” field.

8. To add sub-tabs to the newly defined tab, places a check mark in the field entitled “tab contains sub-tabs.”

9. Selects OK.

The new tab is now displayed at the top of the monitor display. The new tab should be to the right of the other tabs. A user can create multiple user-defined tabs.

In order to modify or delete a user-defined tab, the user highlights the tab then right clicks with the mouse. The user will be prompted to modify or delete the tab.

After creating a user-defined tab, the user can now begin to place securities for display within the newly created tab. To add securities to the tab, the user performs the following:

Clicks on the user-defined tab.

Clicks on the “Add” button located in the bottom right of the monitor display. The “Search” screen will appear.

Enters the search criteria.

From the results screen, selects the securities to add. Multiple securities may be added in one action by using the control or shift key while highlighting the securities with the mouse.

Clicks OK.

In addition to the functional description above, instruments can be added into the monitor directly from the search function.

To delete a security from a user-defined tab, the user performs the following:

Activates the user-defined tab

Highlights the securities from within the tab.

Clicks the remove button located in the bottom right of the monitor display.

Clicks OK.

Once a user has created a new tab by following the steps above, he can now create sub-tabs that will be specific to the tab that was created. In order to create a new sub-tab the user must proceed as follows:

1. Create a tab as defined in the preceding section.

2. Click on the new tab.

3. The user will see “No Tabs Defined.” The user must click on the “Add User Tab” button.

4. The “Add New Monitor Tab” window will be displayed.

5. Type in the name of the new sub tab in the “tab name” field.

6. Select OK.

The user should now see the new sub-tab displayed at the bottom of the monitor display. The new sub-tab is specific to the tab that is activated.

Once a user has created at least one sub-tab for a specific user-defined tab, he can create additional sub-tabs as follows:

1. Activate the user-defined tab where you want to create a sub-tab.

2. Using the mouse, place the arrow to the right of the last sub-tab created for that user-defined tab. Sub-tabs are located at the bottom left of the Monitor display.

3. Right click on the mouse.

4. Click on the “Add User Tab” button.

5. The “Add New Monitor” Tab window will be displayed.

6. Type in the name of the new tab in the “tab name” field.

7. Select OK.

In order to modify or delete a user-defined sub-tab, the user highlight the tab then right clicks with the mouse. The user will be prompted to modify or delete the sub-tab.

Turning to FIG. 2U, shown therein is the books screen 371. The Books area of the service functionality allows a user to create user-defined Book pages for the issues he wants to follow in detail. Unlike the monitor pages, which only provide the best bid and offer, the Books will display all bids and offers for that security in the system.

A user can create a single Book by clicking on the “Books” Button from the navigation area 217 (FIG. 2D) located vertically down the left column of the screen. Next, the user clicks on the area with the message “Click here to add a new issue.” The Search window will appear. The user then enters his search criteria with the Search window and clicks on the “Search” button at the bottom left corner of the window. In the Results page, the user selects his desired bond and clicks on the “Add to Books” button. In addition to the functional description above, instruments can be added into the book directly from the Search function.

A user can create multiple Books by clicking on the Search function in the navigation menu 217 (FIG. 2D). The user then enters his search criteria with the Search window, clicks on the “Search” button at the bottom left corner of the window. In the Results page, using the control or Shift key on his keyboard, the user selects his desired bond and clicks on the “Add to Books” button.

The Message function in the navigation menu 217 (FIG. 2D) permits a user to send and receive messages to and from the Trading Edge Transaction Support Desk. A flashing envelope on the status bar will alert a user that he have an unread message.

There are two options to retrieve messages: clicking on the envelope from the status bar; or clicking on the “Messages” button.

Turning to FIG. 2V, the message screen 381 displays messages received, with the most recent message appearing first. To read the text of a message, a user clicks on the message and then, clicks “View.” After reading, he can reply to the message or close it. The system also allows a user to click the option to reply from the message screen, thereby skipping the extra step of going through View.

To send a message, the user clicks “New”, types his message on screen 391 (FIG. 2W) and clicks on Send. The message will be stored under the Sent tab for the user's records.

All messages are sent to “Support.” A user may not send messages to other users.

Turning to FIG. 2X, shown therein is the reports screen 395 (FIG. 2X). The Reports feature allows a user to create custom reports. Reports are available for orders and trades, by date and by issuer. If this information is not readily available, the user may execute a search for your trades by clicking on the question mark image 396 directly to the right of the Issuer box. Once the user has specified his criteria, the user clicks the “Load Data” button. The progress bar will display the percentage as the loading process is completed. Once completed, the user can save the data in text format. The start/end date defaults to the current date, but can easily be changed to reflect a desired date range. The data delivered is only for the user's orders and trades.

When a user is finished trading for the day and has allocated all of his trades, or if leaving his workstation unattended, the user should exit the system. Exiting the system will cancel any outstanding orders. Clicking on Exit opens the dialog box in FIG. 2Y. Clicking on Exit again confirms exiting of the system. The system will go through a disconnect process during which the closing screen of FIG. 2Z is depicted.

Alternative Embodiment

The above FIGS. 2A-Z depict an exemplary embodiment of the client graphical user interface for trading municipal bonds. Other embodiments can be used for trading other instruments, such as high-yield bonds, emerging market bonds, convertible debt, etc. To do so, specific client applications may be generated using the templates provided in FIGS. 2A-Z for municipal bonds.

Shown in FIG. 2Q is another exemplary embodiment of an instrument search screen 240 that includes specific tabs for each market. This screen 240 allows the user to select in which market segment the user would like to search 250, e.g., High Yield or one of the additional market segments to be made available on a continuing basis, such as Emerging Markets, Convertible Debt, etc., which are selectable by opening the drop down menu next to the high yield segment 250. A user is able to specify the name of a specific Issuer 249, able to specify a particular CUSIP (which is a universal bond or security identifier) 252, or a range of coupon rates 253.

In the body of the window 254, the system will display the name of security 255, a full description of the security 256, the CUSIP/ISIN 257 where applicable, the coupon rate 258, the maturity date 259 and the number of securities found that match the inputted criteria. The system will retrieve the first hundred records that match the stated criteria 260.

The buy order may be modified to include three additional fields which show if the security is trading flat (“Flat”) 279, whether this security is subject to SEC Regulation S (“Reg S”) 280 or if it is subject to SEC Rule 144a (“144a”) 281.

Monitor screens can be modified to enable the user to view information by market segments. Along the top, just under the word Monitors are three tabs, one for each market segment currently served by the system: High Yield market, emerging markets, Emerging and the convertible debt market, Converts. In addition the users pin create new tabs tailored to that users specific needs or desires.

When a particular Market Segment tab is selected all of the information in the display will be specific to that particular market segment. Within each Market Segment tab there is a group of sub-tabs that will appear across the bottom of the screen and which are specific to market segment that is activated.

Turning to FIG. 2Z, shown therein is the monitor screen for the High Yield bond market as is evidenced by the highlighting of the High Yield tab 610. Within the High Yield tab there are three sub tabs Most Active 611, Distressed 612 and New Issue 613.

The Most Active tab and will provide the user a list of the most actively traded in issues on the system. The Distressed tab would provide the user a list of securities that satisfy certain criteria for being considered distressed. These criteria are, inter alia, flat trading, and a yield to equals or exceeds a predetermined value. The system will display the issue identified, the coupon, maturity, type and to bids and offer for the security as well as a quantity at last priced at which it traded. The New Issue tab will provide a list of new issues as they come to market however they will not be traded on the Bond Link system until they have broken syndicate.

Turning to FIG. 3A, wherein is shown the Convertible Securities Monitor as is evidenced by the highlighting of the Converts tab 620. This screen also provides tabs at the bottom for Most Active 621, Distressed 622 and New Issue 623. Information provided by these tabs is the same type of information set out in previous paragraph for the High Yield Monitor.

Turning to FIG. 3B, therein is depicted the Emerging Markets monitor as is evidenced by the highlighting of the Emerging tab 630. At the bottom of the screen are four tabs: Majors 621, Others 622, Corporates 623 and New Issue.

The Majors tab provides the user a list of securities issued by the governments of the major emerging markets. Examples of these would be, inter alia, securities issued by the governments of Argentina, Mexico and Brazil.

The Others tab would provide a list of government securities from less developed countries such as securities issued by, inter alia, Egypt, Poland and Costa Rica.

The Corporates tab will provide the user with a list of corporate securities issued by corporations located in those countries considered to be major emerging markets.

The New Issue tab 624 to provide the user list of new issues from emerging markets as they come to market however new issues will not be traded on the Bond Link system until they have broken syndicate.

Insurance Embodiment

An embodiment of the present invention allows municipal securities dealers, institutional investors and broker/dealers representing retail customers to transact in municipal bonds in the secondary bond market, transact for insurance in conjunction with secondary trades of municipal bonds, and obtain insurance on municipal bonds issues held in one's portfolio.

This embodiment of the present invention: increases the insurance provider's competitive advantage by offering clients an intuitive, Internet-based system to transact for municipal bond insurance; increases revenues by transacting with a larger customer base, increases responsiveness to customers—increased customer satisfaction; reduces the processing time of each transaction by utilizing an electronic interface; reduces overhead by removing part of the manual administration process; and provides an audit trail of all system requests for municipal bond insurance and all issuance of bond insurance.

The benefits to market participants and municipal insurance purchasers are numerous. This embodiment of the present invention provides a level playing field by offering an anonymous and transparent transaction service based on strict price/time priority. Moreover, this embodiment provides added efficiency to the market by allowing users to transact and insure municipal bonds through one user interface. Furthermore, this embodiment of the present invention provides price visibility into a marketplace that is currently fractured and regional in nature, while offering all clients the ability to view best available price in the market. In addition, this aspect of the present invention provides a process for purchasing bond insurance at the moment it is most desired, i.e., when the bond being insured is purchased (the so-called point of sale), and when it can be most properly valued. Thus, with a single mouse click, a user can purchase both a bond and insurance for that bond.

Overview

This embodiment of the present invention enables insurance of municipal bonds in the secondary market without a trade, offers insurance for municipal bonds in conjunction with a trade, and enables transactions in municipal bonds in the secondary market, all via the same user interface.

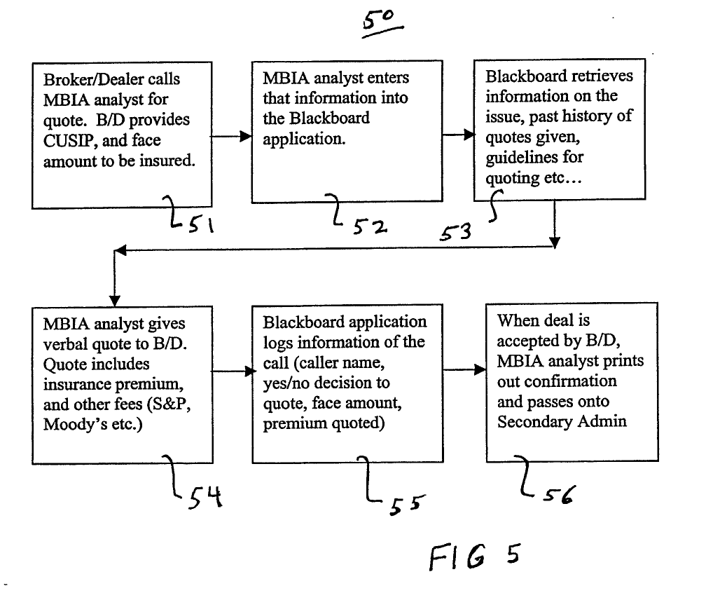

Turning to FIG. 5, shown therein is a conventional process 50 for obtaining insurance for a bond. The broker dealer first calls an insurance analyst, such as one at MBIA, and requests a quote (step 51). The request for a quote includes the CUSIP and the face amount to be insured. The Insurance provider analyst enters this information into an insurance computer system, an example of which is known as “Blackboard” (step 52). The insurance computer system retrieves information on the issue, past history of quotes given, guidelines for quotes, etc. (step 53). The insurance analyst provides a verbal quote to the broker/dealer, which includes the insurance cost (or premium) and any other fees (S&P, Moody's, etc.) (step 54). The insurance computer system logs information of the call (caller name, yes/no decision as to the quote, the face amount and the premium quoted (step 55). When broker dealer accepts the deal, the insurance analysts prints out a confirmation report and passes the order into secondary administration.

Currently, an insurance provider responds to quotes from Broker/Dealers, Portfolio Managers, individuals and UIT Sponsors and issues insurance on municipal bonds trading in the secondary market. The insurance provider does not receive requests for secondary insurance other than from telephone calls from these Municipal market participants.

If a broker dealer calls the insurance provider for an insurance quote on a known issue (step 55), in most cases an analyst can return a quote (step 54) within a few minutes (in some cases within 30 seconds). If the issue is somewhat obscure, the analyst may be required to conduct additional research, in which case the quote can take anywhere from a few hours to a few days.

The flow chart depicted in FIG. 6 depicts an order flow 60 for quoting on, and issuing bond insurance via an Internet-based bond trading system according to one aspect of the present invention. A user requests insurance via the graphical user interface described above (step 61). The bond trading system transmits a request for a quote directly to the insurance computer system (step 62). The insurance computer system then retrieves information on the issue, past history of quotes provided, guidelines for quoting, etc. (step 63). The insurance computer passes a response to the bond trading system, which quote includes the premium, the availability of the insurance, and any other fees, such as S&P, Moody's, etc. (step 64). The insurance application logs the following information in its database: the trader name, yes/no decision as to whether a quote was issued, and the face amount and rate quoted (step 65). In this case, the name of the trader is the bond trading system. The identity of the trader is not passed to the insurance provider, as it is not relevant to the insurance quote and enables the system to maintain the anonymity of the traders. By making this transaction (i.e., the insurance transaction) anonymous, this aspect of the present invention encourages traders that might otherwise be reluctant to requests quotes to do so. For example, a trader may not wish to request a quote on a particular bond because it could tip off other traders as to his intentions if the insurance provider does not maintain the request confidential. By removing individuals from the process of quoting municipal bond insurance, this embodiment closes one possible source of leaks of large bond purchases.

When large amounts of money are at risk, it becomes difficult to guarantee the confidentiality of a given transaction. Even the mere fact that a request for a quote on a large quantity of a particular bond exists can cause adverse market movement. Consequently, some traders, particularly large institutional traders, may be reluctant to request quotes on large orders before implementing the trade to protect their position in the marketplace. The present invention removes this impediment by maintaining the anonymity of the trader all the way through the insurance quoting process. Thus, for the first time large bond orders can be insured at the point of sale without fear of the market moving adverse to the trader as a result of requesting insurance. As the bond trading system interfaces directly with the insurance computer system, without requiring human intervention, this embodiment of the present invention ensures complete anonymity and non-disclosure of the fact that an insured bond order is being implemented.

The client application of this embodiment may be installed on terminals located at the offices of municipal securities dealers, institutional investors and broker dealers representing retail customers. In addition to these venues, retail customers will gain access via a data feed from the scrolling ticker and the books, which can be broadcast by certain electronic brokers to their clients.

There are over 1.3 million registered CUSIPs for municipal securities. This embodiment of the present invention obtains data via subscription to the J. J. Kenny database and has access to all registered CUSIPs. The system may list approximately 50,000 CUSIPs that will be eligible to trade. The general criteria for selecting CUSIPs to list include: (1) Securities from the most actively issued and traded states/territories; (2) maturities with at least $5 million face amount outstanding; (3) securities that insurance providers list for insurance; (4) serial bonds that are actively traded. The following states have the most outstanding CUSIPs: California, New York, Florida, Illinois, Minnesota, Michigan, Pennsylvania and Texas. It should be noted that the most active issues with respect to requests for insurance (highest volume of requests for bond insurance) are California, New York and Puerto Rico. Other embodiments may include bonds from other states and other specific issues that are actively traded and/or actively insured in the secondary market. The system remains flexible enough to allow for daily and intra-day additions to the master securities list.

This embodiment may include an interface with electronic brokers (e.g., E*TRADE). Moreover, this system can include the entire Municipal Securities listings of over 1.3 million CUSIPs, other insurable securities such as corporate IOUs, Yankee bonds, or international securities such as Hydro Quebecs, and can transact in short-term, money market municipal securities.

Interfaces to certain third parties include: a custodian, such as US Trust, which is a custodian for municipal bonds insured by the insurance provider, such as MBIA, in the secondary market. Within hours of each insurance transaction, the insurance provider sends the custodian the insurance policy of the insured deal. The custodian interacts with the insurance provider and its client as follows:

1. The insurance provider sends the insurance policy to the custodian after each transaction. The policy includes the customer name, uninsured CUSIP and face amount of each transaction.

2. The Custodian sets up a position in the customer's name.

3. The insurance provider instructs the customer to deliver the uninsured CUSIP to the custodian (referencing an account and policy number).

4. Customer delivers the uninsured CUSIPs to the custodian.

5. The custodian “immobilizes” the old CUSIP in the face amount received.

6. The custodian issues (creates if necessary) the enhanced CUSIP to the client. Based on this procedure, the system interacts with the custodian after each insurance transaction. All municipal bond transactions done via the system are sent to the custodian.

The system includes an interface to a database of bonds, such as J. J. Kenny. The insurance provider obtains the bond data from the bond database for the master securities list for municipal bonds. The system uses data from the bond database provider to populate the master securities list.

The system includes an interface to the CUSIP Bureau, which requires that all electronic systems that display or redistribute CUSIPs and the information surrounding CUSIPS be licensed with the CUSIP Bureau. The CUSIP Bureau is also the entity responsible for assigning new CUSIPs to municipal bonds.

The assignment and notification of new CUSIPs for insured securities is a manual process. Currently, The insurance provider's Secondary Administration applies directly to CUSIP Bureau via the Internet for enhanced numbers. The CUSIP Bureau usually responds within one hour.

An interface between the insurance provider, such as MBIA, the system, and the CUSIP Bureau exists. The CUSIP Bureau has an electronic capability that sends the insured CUSIP back within a few minutes.

TIPS Inc. provides calculation libraries for calculations specific to the municipal bond market.

The system includes an interface to a clearinghouse. Municipal bond transactions are cleared through Schroeder's. The clearing process is similar to the current process used to clear high yield bonds.

The Municipal Securities Rule-making Board (MSRB) requires that all transactions be reported to them at the end of each day. The system includes an interface to MSRB.

As per the MSRB rules 13, 15 and 17 (and any other rules not identified here)—the system is a licensed Broker/Dealer for Municipal Securities.

The system remits payment for insurance premiums and associated fees to the insurance provider on a monthly basis.

The clearing agent for the system collects insurance premiums from our clients as part of the trade settlement process. This will be the case for all insurance transactions that are conducted as part of a buy/sell of a municipal bond.

Functionality

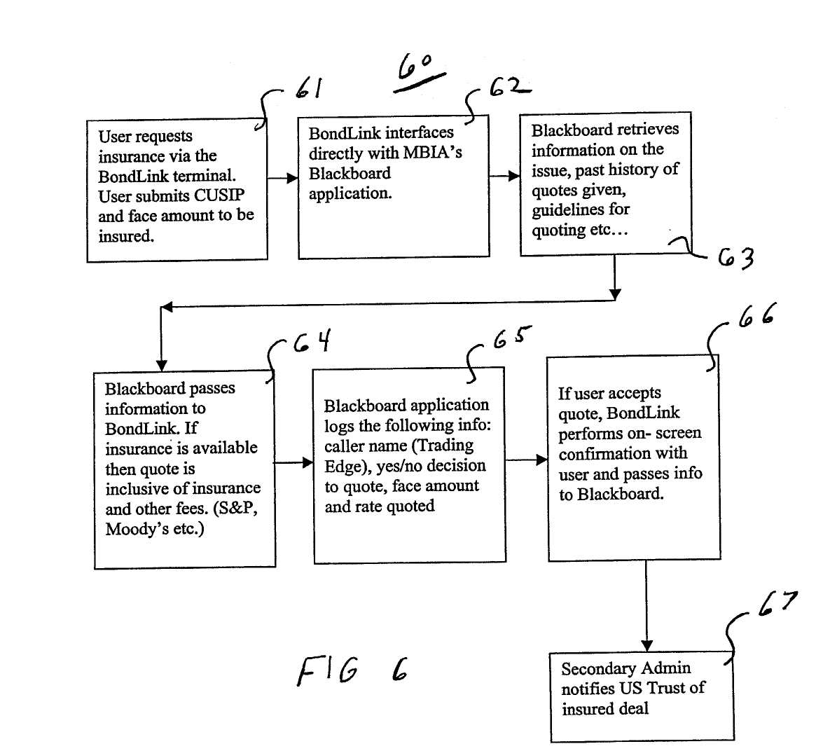

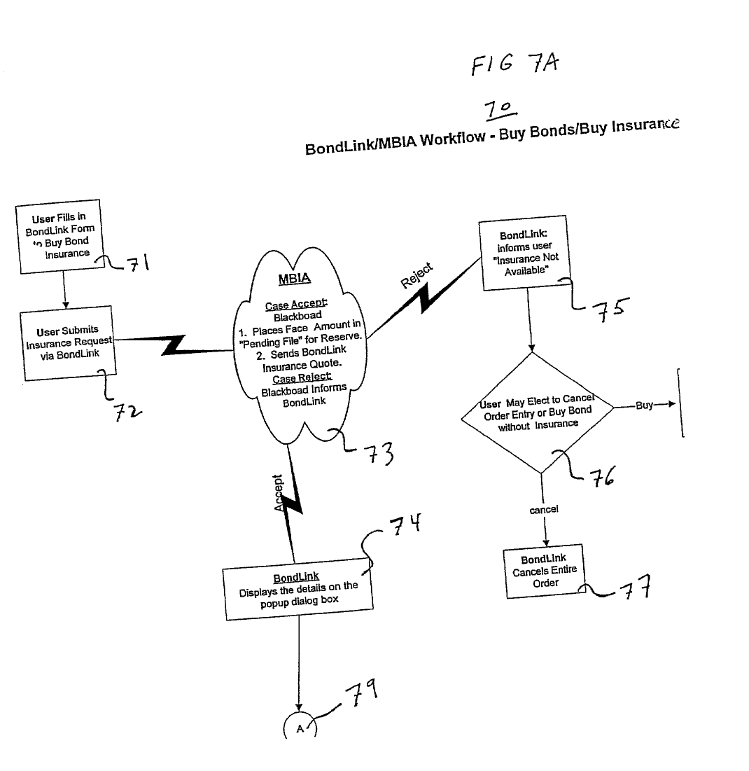

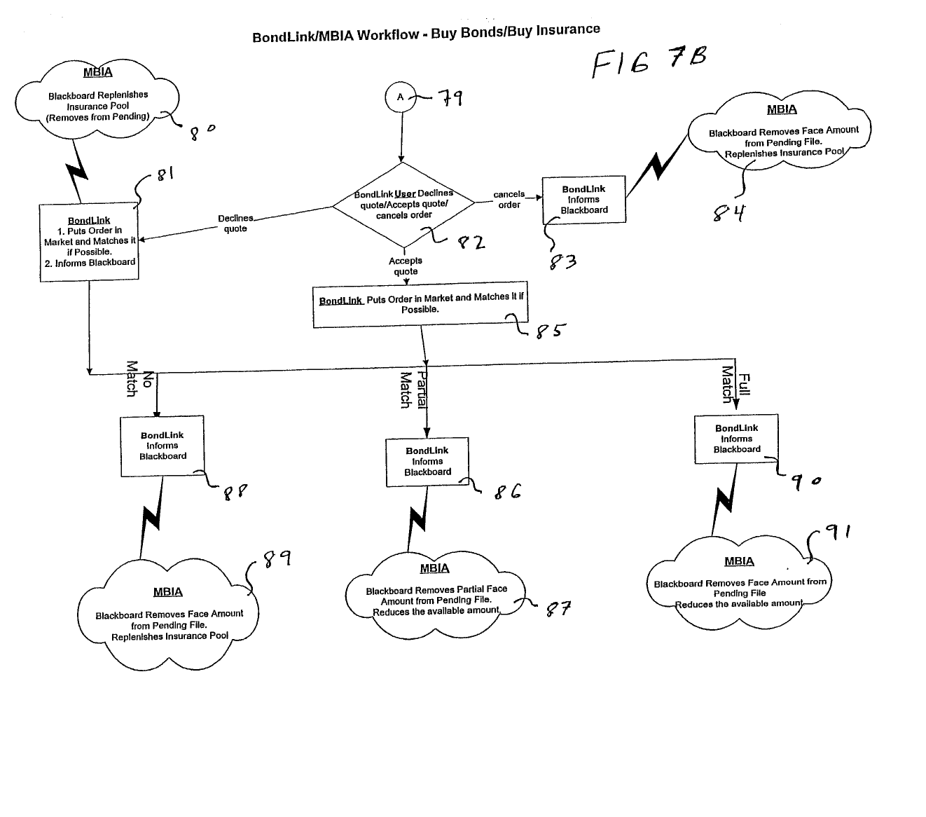

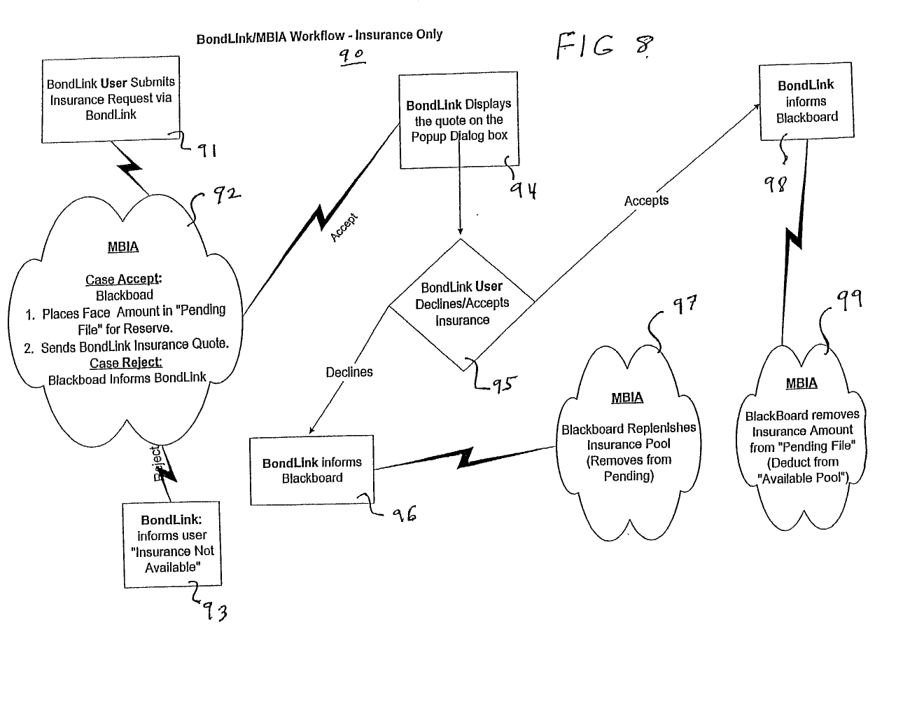

The screen for the municipal bond trading has been described above. FIGS. 7A-B depict an exemplary embodiment of a process 70 for a bond transaction in conjunction with insurance.

If a user wants to buy a bond and insure it at the same time, the order flow is as follows. If an uninsured bond is available to trade on the system, a user may buy insurance for the bond in conjunction with buying the bond. This section describes that process.

After entering the required information on the buy order form (including the “buy insurance” option) (step 71) the user can select “submit request” or “cancel request” option (step 72). If the user selects the cancel request option the buy order form will be removed from the screen. The user will be returned to the screen that was activated prior to bringing up the buy order form.

If the user selects the “submit request” option, the system will delay entering the buy order until it determines if insurance is available. The order will first be routed to the insurance provider computer system.

Once the order is submitted to the insurance provider, the insurance provider may accept or reject the quote. First, the insurance provider computer places the face amount of the request in the pending file for reserve. Second, the insurance provider computer sends the bond trading system an insurance quote, in case of accepting the order, and sends a reject message in case of rejecting the order (step 73).

There are three possible results to the user's request for insurance. He can be denied insurance, offered insurance for the full amount, or he can be offered insurance for a partial amount. The following sub-sections cover each scenario.

If insurance is not available for any reason as determined by the query to The insurance computer system, the Order Entry dialogue box will display: “Insurance for this issue is not available on the system at this time (step 75). Please call the insurance provider's telephone number for further details.” The user's only option will be to cancel the request (or buy the bond without insurance, which may be treated as a different order) (step 76). When the user cancels the request he will be returned to the Buy order form. The user can enter a new order (i.e., without insurance) (step 78) or he can cancel the buy order (step 77).

If the user does not want to buy the bonds he can select “clear” or “cancel” from the buy order form. If the user selects “clear,” the information in the buy order form will be deleted and the user will be left with a blank buy order form. If the user selects “cancel” the buy order form will be removed from the screen. The user will be returned to the screen that was activated prior to bringing up the buy order form.

If the user wishes to transact in the bond without the insurance he can select deselect the “buy [insurance provider] Insurance” option from the buy order form and re-submit the order, which may be treated as a new order by the system.

If insurance is available the Order Entry dialogue box will appear and display all the information regarding the order (including the insurance information) (step 74).

The Insurance Information includes: the insurance cost per bond (all-in price including all applicable administrative fees), the total insurance cost for the order (all-in price including all applicable administrative fees), the net yield to worst including the insurance fees and TE markup/markdown, delivery instructions for the uninsured CUSIP, the settlement date for the insurance, and an insurance provider reference number. Note that Net price and Net Yield will reflect the cost of insurance. When the quote is returned to the user, the system re-calculates the Net price and net YTW using the insurance cost per bond as part of the calculation.

The bond Information includes: security, quantity, price, net yield (net of markup/markdown), trading conditions and settlement date. Additionally, the box will display in tabular form the following: dollars for bond transaction, accrued interest (if applicable), sub total, markup/markdown in dollars, total insurance cost in dollars, and total net dollars for settlement.

There is a possibility that the outstanding order in BondLink will be partially filled before the user is able to transact. Therefore, the user may transact in a bond for an amount less than originally intended and an amount less than the face amount quoted by the insurance provider. Therefore, the insurance premium quoted by the insurance provider is good for a minimum and maximum threshold. If the user trades in a quantity less than or greater than the quantity quoted, but within the minimum and maximum threshold (determined by The insurance provider) the cost per bond quote is still valid. If the quantity is outside the threshold, the user will be required to resubmit a request for insurance.

As soon as the insurance computer system passes a quote to the BondLink system, the insurance computer system places the face amount of the request in a “pending” state (step 73). The face amount must remain in this pending state until the user has made a decision to purchase (or not purchase) the insurance, or until the end of the trading day whichever comes first. The pending state will act as a temporary draw down on the available insurance for that issue.

The user can review the insurance/bond quote and respond by either declining the insurance or accepting the insurance (step 82).

If the user determines that he does not want to continue with the transaction, he can cancel the order from the order dialogue box. When the user cancels the request he will be returned to the Buy order form. The user can enter a new order (i.e., without insurance) or he can cancel the buy order. If the user cancels the order, the bond trading system will inform the insurance computer system (step 83), which will remove the face amount from the pending file and replenish the insurance pool (step 84).

If the user declines the insurance, the BondLink system will inform the insurance computer system (step 81), which will remove the face amount that was requested for insurance from the “pending shelf” and place it back into the available shelf for future requests (step 80).

If the user selects the “accept” button from the order dialogue box, the order will be placed in the BondLink system on a price-time priority (step 85). The insurance will not be issued until the buy bonds order is executed.

Since all orders are matched on a price-time priority, there is a chance that the original standing order the user attempted to trade on and insure is no longer active (either canceled, modified or traded upon). Or the order may only be partially available (portion of the resting order was traded upon or modified by the originator of the order). In the event that the order cannot be matched at all the BondLink system will inform the insurance computer system.

If the match did not occur, the BondLink system informs the insurance computer system (step 88), which removes the face amount that was requested for insurance from the pending shelf and places it back into the available shelf for future requests (step 89).

The User may accept Insurance and a Partial fill Occurs. If a partial match did occur, the BondLink system informs the insurance computer system (step 86), which deducts the face amount that was traded from the pending shelf and deducts the amount from the available shelf. The insurance computer system keeps the face amount that did not trade in the “pending” state. The face amount remains in this pending state until the user has either cancelled the order or the remainder of the order is matched by the system.

If a full match occurs, both the match and the insurance purchase are final. The bond trading system informs the insurance computer system (step 90), which removes the face amount from the pending file and reduces the available amount (step 91). The user's trade blotter is updated with both the bond and the insurance transaction. The deal is also routed to the insurance provider computer system for update.

BondLink notifies the user (via the trade blotter) of the enhanced CUSIP and other trade details.

If the enhanced CUSIP does not exist, the following steps occur:

1. The insurance provider requests new CUSIP from CUSIP Bureau.

2. CUSIP Bureau faxes the new enhanced CUSIP to The insurance provider

3. The insurance provider staff will enter the new enhanced CUSIP on The insurance computer system and fax the new enhanced CUSIP to Moodys, S&P and Bloomberg.

4. The insurance computer system will place the new information in a queue

5. BondLink will poll the queue on a regular basis and retrieve the enhanced CUSIP.

6. BondLink will deliver the enhanced CUSIP to the user's trade blotter.

It should be noted that the J. J. Kenny database will not have this new enhanced CUSIP until late in the day the enhanced CUSIP was created, or more likely, not until the following day. Therefore, as the system receives a change file from J. J. Kenny at the end of each business day, it will take 1-2 calendar days for the system to get the new enhanced CUSIP information from J. J. Kenny.

When the match occurs and the insurance is final, BondLink informs the insurance computer system, which removes the face amount that was requested for insurance from the pending shelf and updates the insurance computer system to reflect that the insurance was issued. The insurance computer system deducts the face amount from the available shelf. The insurance computer system then issues all necessary updates and alerts specific to the insurance provider procedures.

If the user wants to place his offer in the market and insure the bond if the offer is hit, i.e., accepted by a counter party, then the system may allow pre-offer quotes.

Turning to FIG. 9, the system provides the capability for a standalone request for insurance. The system allows a user to request a quote for bond insurance as a stand-alone transaction. In other words, the user is not looking to transact or trade a bond; he is only looking to insure a bond that he already has in his portfolio.

The user selects a tab located along the left column of the BondLink terminal. The tab may be labeled “The insurance provider Insurance.” When the user selects the tab, the top half of the screen displays an order form.

When a user is requesting insurance for a security as a stand-alone the following information must be entered: CUSIP, Quantity, and Minimum and Maximum Quantity. The system may enforce a minimum and maximum quantity rule at data entry. The minimum and maximum quantities are system configurable so these limits may be adjusted as the market dictates. Some possible settings for minimum and maximum are as follows: Minimum face amount for requesting insurance=$100,000; Maximum face amount for requesting insurance=$10,000,000. If the user violates either minimum or maximum amount, the system displays a message informing the user that the amount is too low/high.

There is one exception to the minimum quantity rule for insuring a bond. If the bond is a 0% coupon, the minimum quantity for insuring is 2.5 times the standard minimum quantity. In this case $250,000 is the minimum quantity that the insurance provider will ensure for 0% coupon bonds via BondLink.

After entering the required fields, the system will access the master reference files and fill in the following information on the insurance order form: Issuer, Description, Coupon, Maturity, Dated Date, Rating, Conditions and any Additional Conditions.

FIG. 9 shows the “insurance only” order process 90 and how the order flows through the system.

After entering the required information on the insurance order form the user can select “submit request” or “cancel request” option (step 91). If the user selects the cancel request option his insurance buy order dialogue box will be removed from the screen.

If the user selects the “submit request” option, BondLink will route the order to the insurance provider computer system or any insurance provider computer system.

When BondLink receives a response from the insurance computer system, BondLink will display an Order Entry dialog box to the user (step 94). There are two possible results to the user's request for insurance (step 94). He can be denied insurance or he can be offered insurance.

If insurance is not available for any reason as determined by the BondLink query to the insurance computer system, the Order Entry dialogue box will display: “Insurance for this issue is not available on BondLink at this time. Please call [telephone number and insurance provider] for further details” (step 93).

The users only option will be to cancel the request. When the user cancels the request his insurance buy order dialogue box will be removed from the screen.

If insurance is available the Order Entry dialogue box will appear and display: the insurance cost per bond (all-in price including all applicable administrative fees); total insurance cost for the order (all-in price including all applicable administrative fees); delivery instructions for the uninsured CUSIP, and The insurance provider reference number (step 94).

As soon as the insurance computer system passes a quote to BondLink, the insurance computer system places the face amount of the request in a “pending” state (step 92). The face amount remains in this pending state until the user has made a decision to purchase the insurance (or not purchase insurance), or until the end of the trading day whichever comes first. The pending state acts as a temporary draw down on the available insurance for that issue.

The user can review the quote and respond by either declining the insurance or accepting the insurance (step 95).

If the user declines the insurance he will be returned to the buy order form.

If the user declines the insurance, BondLink informs the insurance computer system (step 96), which removes the face amount that was requested for insurance and places it back into the available shelf for future requests (step 97).

The user's trade blotter is updated with the insurance transaction. The insurance transaction is also routed to the insurance computer system for update.

BondLink notifies the user (via the trade blotter) of the enhanced CUSIP and other trade details. If the enhanced CUSIP does not exist, the following steps will occur:

1. The insurance provider requests new CUSIP from CUSIP Bureau.

2. CUSIP Bureau faxes the new enhanced CUSIP to The insurance provider

3. The insurance provider staff will enter the new enhanced CUSIP on The insurance computer system and fax the new enhanced CUSIP to Moodys, S&P and Bloomberg.

4. The insurance computer system will place the new information in a queue

5. BondLink will poll the queue on a regular basis and retrieve the enhanced CUSIP.

6. BondLink will deliver the enhanced CUSIP to the user's trade blotter.

J. J. Kenny will not have this new enhanced CUSIP in their database until late in the day in which the enhanced CUSIP was created, or more likely, not until the following day. Assuming the system receives a change file from the bond database provider, e.g., J. J. Kenny, at the end of each business day, it will take 1-2 calendar days for the system to get the new enhanced CUSIP information from the bond database provider.

If the user accepts the insurance, BondLink will inform the insurance computer system (step 98), which removes the face amount that was requested for insurance from the pending shelf and updates the insurance computer system to reflect that the insurance was issued (step 99). The insurance computer system then issues all necessary updates and alerts specific to the insurance provider procedures.

The scrolling ticker window appears in the lower right quadrant of the screen. The purpose of the display is to list bids/offers/transactions for bonds. The scrolling ticker will not display any orders/transactions for “insurance only.” A separate tab may be provided to an insurance user to list the various insurance quotes in the system.

Similar to the above embodiment functionality, information for each trade will be displayed across two rows in the trade blotter. In the case where insurance was not part of the transaction, the insurance fields will display “N/A.”

In the event that a bond was purchased and insured on BondLink, the insurance provider will deliver a new CUSIP for the insured instrument. The new CUSIP will be placed in the users trade blotter under the “new CUSIP” field. The new CUSIP will also appear in the control center trade blotter. In the event that the insurance provider does not have the new CUSIP when confirming the insurance transaction, the insurance computer system will return the value “requested.” The word “requested” will appear in the “new CUSIP” field in the user's and the control center trade blotters.

In addition to the current tabs for Active and Cancelled Orders, another tab in the Orders Tab is provided entitled “insurance orders.”

This view enables the control center user the ability to check the status of insurance orders. The view will display all insurance orders for the day. The primary purpose of the display is to give the transaction desk and operations personnel the ability to see what insurance orders are in the system, what is pending, what is denied and what is completed.

The display is dynamically updated with the following:

Field Name=Field Description

User Alias=the unique ID that BondLink assigns the user.

Quote ID=Designated order number from BondLink (unique for each order)

The insurance provider ID=Designated order number from the insurance provider (unique for each order)

CUSIP=Unique identifier of the security

Enhanced CUSIP=Once the order is insured (in part or in its entirety) the new CUSIP Passed on from the insurance provider

Issuer=the issuer of the security

Coupon=Coupon of the security at issuance (listed below issuer)

Maturity=Date when the security matures (listed below issuer)

Status=Designates if the insurance is denied, partially filled, pending or done.

Time=Time order was placed in BondLink (EST)

Qty=Face amount of order

Remaining Qty=the qty of the order that is still not insured. (dynamic, will grow as the order is filled)

Settled Qty=the qty of the order that has been insured (dynamic, will grow as the order is filled)

Minimum Fill=the minimum quantity to be insured (attribute of the order. Must be a minimum of 100 bonds)

Total Cost=Total insurance cost for the settlement qty. (dynamic, will grow as the order is filled)

Cost Per/Bond=Cost of insurance per bond.

Firm=Displays the firm name of the user.

Name=Displays the name of the user.

As with other orders, the system enables the user to cancel orders for insurance only using the same user interface described above with regard to other orders. If the user's workstation loses connectivity to the System, all open orders are cancelled by the system.

The transaction system interfaces with the insurance provider's proprietary systems, such as Blackboard and MIDAS. Similar interfaces can be made to other insurance providers as the existing interfaces have been designed to be standard and non-specific to the insurance provider by using XML as the messaging transport protocol, and using easily modifiable Data Type Definitions (DTD's). These systems contain much of the historical data, terms and conditions and other information on each Municipal issue.

The Blackboard application is used by the insurance provider's Secondary Markets Group as a tool to assist in them in issuing insurance for Municipal Bonds in the secondary marketplace. The list below highlights some of the information contained on Blackboard.

The face amount of a particular issue that The insurance provider is willing to insure

Whether or not a portion of the issue has been insured in the secondary market

If applicable, the face dollar amount that has been insured

If applicable, Supplemental CUSIP numbers

Sector Codes

History of insurance quotes given for a particular security

Calculations of various administrative fees such as CUSIP, Moody's and S&P fees.

Other pertinent information

These systems also link to and perform the risk analysis that set guidelines and assist the bond analyst in pricing insurance.

Currently the insurance provider allots a specific amount of available capacity for credits in its database. There are several groups within the insurance provider that are allotted portions of that total availability. These allotments are referred to as “shelves.” The Secondary Markets Group within The insurance provider has individual shelves from which to pull down insurance. It is envisioned that Trading Edge will be added as a sub-shelve under the Secondary Markets Group.

The Secondary Market Group at The insurance provider will be responsible for setting up the insurance parameters for the Trading Edge shelf. Each time Trading Edge queries the insurance computer system with a request for insurance, the system will look at the Trading Edge shelf to determine if there is insurance available in that CUSIP.

Each time an insurance quote is requested, BondLink will automatically update the insurance computer system. The insurance provider needs to determine if the MIDAS can be updated dynamically by the insurance computer system for Trading Edge approved shelves.

The system may allow the minimum and maximum thresholds to be configurable by credit and CUSIP.

When The insurance computer system gives an insurance quote via BondLink, that quote is good until the end of the trading day or when the user declines the quote, whichever is the earliest. When The insurance computer system gives a quote for a specific face amount to be insured, The insurance computer system must place that face amount into a “pending shelf” until such time that that user accepts or declines the insurance, or the trading day has ended. If either of the latter two events occurs, the insurance computer system will remove the face amount from the pending shelf and replenish the availability shelf.

Although the insurance provider insurance quote does not expire until the end of the trading day, the time length is configurable to account for adjustments as the market dictates.

It is envisioned that the time-out period (as defined above) is universal across all Municipal instruments offered on the BondLink service. The time-out period may be defined on a per credit or per instrument basis.

The insurance provider can track pending capacity within the insurance computer system.

The system should have an alert mechanism that notifies the bond analyst if a RFQ comes in for a face amount that is larger than the parameters set within the insurance provider's internal system. Other alerts may be required.

Adding CUSIPs

Whenever an operator of the system wants to search for, add or activate a CUSIP(s), it will be done via the control center. There is an added tab in the Instrument tab entitled “Active Securities Management.” When selected this tab will allow control center users to search, add and activate CUSIPs.

The left side of the Active Securities Management screen allows control center users to type in a CUSIP number to see if that CUSIP currently exists in the BondLink DB. When the user types in the CUSIP and selects the “search” button, the system will return one of the following three responses:

Nothing Found (CUSIP is not in the BondLink DB)

CUSIP # and “N” (indicating that the security is in the BondLink DB, but not activated and therefore not available for trading in BondLink).

CUSIP # and “Y” (indicating that CUSIP is in the BondLink DB and is available for trading).

When a control center user wants to add a new CUSIP(s) to BondLink he can do so via the right side of the Active Securities Management screen. The user can add instruments in one of two ways.

The control center user can add individual CUSIPs by typing in the CUSIP number in the “new CUSIP” field and then selecting the “Add” button. This action will result in the system going out to the J J Kenny DB, finding the CUSIP and returning it to the BondLink DB. The security will now be in BondLink, but INACTIVE.

In order to see the status of this CUSIP, the user is required to go to the left side of the screen and search for the CUSIP number.

The control center user can add multiple CUSIPs by loading a file into BondLink. The file format to be loaded is simple Excel or CSV files where each CUSIP is listed in its own row. In order to load the file the user will perform the following:

Select the “load File” button

Browse for the file containing the list of CUSIPS

Highlight the correct

Select the “Add” button

This action will result in the system going out to the J J Kenny DB, finding the CUSIPs and returning it to the BondLink DB. The securities will now be in BondLink, but INACTIVE.

In order to see the status of these CUSIPs, the user is required to go to the left side of the screen and search for the CUSIPs numbers.

BondLink users WILL NOT see the CUSIP and will be unable to perform any actions on the CUSIP until the CUSIP is activated. In order to activate the CUSIP the CUSIP must first be added to BondLink. Once a CUSIP is added to the BondLink database the control center user can activate the CUSIP. By activating the CUSIP, the CUSIP is now available for trading.

To activate a CUSIP, the Control Center user must perform the following:

Add CUSIP as described in the previous section

Type in the CUSIP number in the “new CUSIP” field

Select the “Activate” button

In order to see the status of this CUSIP, the user is required to go to the left side of the screen and search for the CUSIP number.

The following fields are required for each security in the bond trading system database:

| | | Record | Record |
|---|---|---|---|
| Field Name | Field Description | Type | Positions |
| State | State or territory (i.e. NY, PA, NJ, Puerto Rico) | QS (01) | 31-32 |
| Issue | The issuer of the security | QS (01) | 33-80 |
| Description | Further description of the security | QS (02) | 50-80 |
| CUSIP | Unique identifier of the security | QS (01) | 7-15 |
| Coupon | Coupon of the security | QS (02) | 24-29 |
| Multi-Coupon | Indicates if the security has a multi-coupon | N/A | N/A |
| | (Always ‘N’ for Munis) | | |
| Maturity | Maturity Date | QS (02) | 36-45 |
| Issue Date | Date of issuance of the security | QS (02) | 14-23 |
| Dated Date | Accrual start date of the security | QS (02) | 14-23 |
| Redemption Price | Face amount that the security will be redeemed at - | N/A | N/A |
| | always Par (1000) | | |
| Bond Purpose / | Further indication of bond (G.O., Revenue, Sewer, | PT | 11-14 |
| Issue Type | Dormitory . . . ) | | |
| Instrument Type | Denotes if instrument is a bond, note, bill . . . | ?? | ?? |
| Pre-refunded | Denotes if pre-refunded, escrowed or other | PR | 40 |
| Type | | | |
| Pre-refunded | Yes or No | PR | 1-2 |
| Pre-refunded date | MM/DD/YYYY | PR | 11-20 |
| Pre-refunded | N/A or a long | PR | 2129 |
| price | | | |
| Taxable | Yes or No | | |
| Escrowed | Yes or No | | |
| Physical | Yes or No | | |
| AMT | Yes or No | | |
| Taxable | Yes or No | | |
| OID | Yes or No | | |
| Price/Yield at | If OID is yes, put in values | | |
| Issue | | | |
| Insured | Yes or No | CR | 1-2 |
| Insurer name | If insured, display the insurers full name (The | CR | 11-70 |
| | insurance provider, AMBAC . . . ) | | |
| First Payment | Date of the first coupon payment | IN | 19-28 |
| Second Payment | Date of the second coupon payment | N/A | N/A |
| Last Payment | Last payment date prior to maturity | IN | 29-38 |
| Accrual Method | Formula to determine how interest is accrued | IN | 51-60 |
| Payment | On what schedule is interest paid (annual, semi- | IN | 39-41 |
| Frequency | annual . . . ) | | |
| Payment Type | The form in which payment is made. ‘Cash’ for | N/A | N/A |
| | Munis | | |
| Interest Rate | States if the interest rate is fixed, floating, stepped | ID | 7-10 |
| | etc . . . | | |
| Interest schedule | If the interest rate is Variable, this gives the | VR | 21-23 |
| | schedule for when the rates will adjust and to what | | |
| | level. | | |
| Call schedule | If callable, the call schedule including call dates | CS | 1-2 |
| | and prices | | |
| Call date | Callable date | CS | 20-29 |
| Call Price | Callable price | CS | 53-61 |
| Moody’s Rating | Will display the Rating from Moody’s | RA | 7-10, 11-16 |
| S&P Rating | Will display the Rating from S&P | RA | 7-10, 11-16 |
| Fitch Rating | Will display the Rating from Fitch | RA | 7-10, 11-16 |

When a Trading Edge control center person sets up users on the system, the control center person must permission the users as per current BondLink. Users can be set up with the following permissions: Muni Trader, Muni Looker, Muni Insurance.

In addition to current permissioning functionality, customers may be set up with the permission to insure or not insure bonds on the system. There are some clients (e.g., competitors of the insurance provider) that will use the bond trading system to trade. The insurance provider will not want to allow these firms to get insurance quotes (and therefore give away their pricing).

Each morning before the trading day opens, the system accesses the J. J. Kenny delta file. This file contains all of the changes to the securities listed on BondLink. This will be done outside of the BondLink system via a file transfer protocol (FTP).

The trading hours for BondLink are configurable and set at the control center. There will not be any changes to this functionality. The start of the trading day may be 7:30 a.m. eastern time.

The system will automatically cancel any resting orders at the end of the trading day. The close of trading is configurable and set at the control center.

The system will automatically cancel any resting insurance orders at the end of the trading day. BondLink will pass on that information to the insurance computer system informing the insurance computer system that each order is no longer active.

At the end of each trading day, trading edge will perform a database backup and copy. The end of day insurance reconciliation between BondLink and the insurance provider compute system may be done manually or automatically. The control center provides a printed reconciliation report that will be used to manually reconcile the day's insurance transactions.

The Header of the Report:

BondLink—The insurance computer system insurance reconciliation report

Report Created: Jan. 12, 2000

Run By: Name of person logged on to CC

Time: 02:10 PM

Fields in the Report:

The fields displayed below should appear as column headings going from left to right across the top of the report.

Trade date

Trans Number (as reported to Lewco as part of the clearing report)

Settlement Date

Company name

User name

User Alias

CUSIP

Description

Coupon

Maturity

Quantity

Ins Cost Per Bond

Total Ins. Cost.

The bottom of the report should total up the “total insurance cost” and the number of insurance transactions.

The insurance reconciliation report will be viewable from within the “clearing” section of the control center. There will be a separate tab for “insurance transactions”.

Trading Edge, Inc. will clear all municipal bond transactions through Lewco. The system generates a clearing file at the end of each trading day and transmits the file to Lewco. In addition to the Lewco file, BondLink will also create a clearing report used for internal Trading Edge purposes.

It should be noted that the content of these reports would be modified to support the insurance transactions that will be available on the Muni service. These transactions will be reported to Lewco. The following sub-sections will describe the contents and the format of the Lewco clearing file and the Trading Edge clearing report.

Each non-insurance-related trade occurring on BondLink is reported to Lewco as two transactions. In its simplest form the transactions are as follows: (1) system buys bonds from customer A; and (2) system sells bonds to customer B. Under normal circumstances the same will apply to non-insured municipal bonds. However, when a user purchases bonds and gets them insured via BondLink, the system will generate four transactions for clearing purposes: (1) the system riskless principal account buys uninsured bonds from customer A; (2) the system riskless principal account sells uninsured bonds to the muni bond exchange account; (3) the system riskless principal account buys from the insured bonds from the municipal bond exchange account; and (4) the system riskless principal sells the insured bonds to customer B.

For insurance transactions the “transaction price”, “net price” and “principal” will be calculated differently for each of the four legs depicted in the example above.

1. TE buys uninsured bonds from customer A

transaction price—normal, same as other bonds

net price—normal, same as other bonds

principal—normal, same as other bonds.

2. TE sells uninsured bonds to a separate new TE account

transaction price—hard coded as $00.01

net price—hard coded as $1.00

principal—hard coded as $1.00.

3. TE buys from the insured bonds from the separate new TE account

transaction price—hard coded as $00.01

net price—hard coded as $1.00

principal—hard coded as $1.00.

4. TE sells the insured bonds to customer B.

transaction price—normal, same as other bonds

net price—includes markup/down and insurance cost per bond

principal—normal, same as other bonds

In the event that the BondLink system shuts down for any reason, all active orders for bonds and insurance will be automatically canceled.

If the insurance computer system is unavailable for any reason, the bond trading system will still operate for trading. If a user requests an insurance quote when the insurance computer system is not available, the bond trading system will return a message to the user informing that “insurance is not available, please try again later”.

The bond trading system may alert users via the messaging facility that insurance is known to be unavailable in circumstances where the insurance provider is not available for extended periods.

The connectivity between the BondLink service and the insurance computer system is done through dedicated telecommunications lines. There exists one live and one hot standby line. In the event that the live line goes down there will be NO disruption of insurance. The hot standby line will immediately go to “live”. In the event that both the live and hot standby lines are unavailable, users will not be able to receive quotes for insurance. BondLink will return a message to the user informing that “insurance is not available, please try again later”.

MSRB publishes Muni prices for approximately 1000 bonds. This pricing information is distributed via J. J. Kenny and other market data sources.

Both the insurance provider and BondLink systems utilizes TIPS calculations. The bond trading system subscribes to the TIPS Municipal Bond calculation libraries, which is used by the insurance provider.

BondLink currently shows “net yield to maturity (YTM)” only. There is a requirement to calculate both the transaction and net yields to other dates such as “yield to call” and yield to pre-refunded dates in order to determine and display the “yield to worst” (YTW)” for Municipal Bonds.

The system may permit trading in non-standard settlement, including WI securities.

The system offers news headlines and corresponding news stories associated to the municipal bond market with particular emphasis on the municipal securities listed on the system.

The Control Center messaging facility may broadcast the list of the insurance provider approved Credits on BondLink. Users can go the message facility and view the list of credits that are eligible for the insurance provider insurance via BondLink.

The call center/help desk has the ability to control the market open/close as well as other account maintenance and system wide functions.

The system runs and prints a reconciliation report between the bond trading system and the insurance computer. This report lists all insurance transactions that occurred on BondLink for a specified period of time. The report may be run at the end of each trading day. A control center user may specify a date or date range to run the report.

The Control Center has the functionality to permission a user to submit the insurance provider insurance requests. When a new user is being set up on the system, a field allows the control center to set up permissioning. One of those permission levels will be insurance (Y/N). If the user is not permissioned for insurance and he tries to select the insurance option the system returns a response that “you are not permissioned for this functionality”.

The bond trading system also provides a pricing feed out of the system. This enables clients to take in their last trades from BondLink via a feed. Clients may also receive all bids and offers from BondLink via this feed. Furthermore, this enables client's to accept this data into their proprietary systems. For example, the insurance provider portfolio management system receives indicative bids and offers from brokers each morning. They receive over 1,000 indicative rates. These rates are then filtered and sorted at the discretion of the portfolio manager. BondLink provides an API to allow our clients to receive live, executable bids and offers.

BondLink has the ability to receive orders via an API. Clients can submit bids and offers (and cancels) via the API. Clients have the ability to submit single orders or many orders. This enables dealers to submit hundreds, possibly thousands of orders via the API.

Buy-side clients may want to enter a specific order when they see a specific price level on their proprietary system. This order comes into BondLink from the client's proprietary system via an API.

Interface to Insurance Provider

The system interfaces with the insurance provider via an XML server. This enables expansion to other and multiple insurance providers using a common interface. The interface is defined by various Document Type Definitions (DTDs). These definitions are listed below.

All Pending Insurance Requests Cancellation DTD

<!--

This DTD should be used when all pending insurance requests are to be cancelled.

In BondLink, the ‘Cancel All’ transactions request will cause this to happen.

<!-- Cancel All Insurance -->

<!ELEMENT CancelAllInsurance (reason, timestamp)>

<!ELEMENT reason (#PCDATA)>

<!ELEMENT timestamp (#PCDATA)>

Single Transaction Cancellation DTD

<!--

This DTD is to be used for a single transaction cancel request.

It is also used if the user rejects the MBIA quote for insurance or when a trade occurs and the request is accepted.

-->

<!ELEMENT CustomerInsuranceDecision (orderid, mbiaid, tradeamt, timestamp)>

<!ATTLIST CustomerInsuranceDecision decision CDATA #REQUIRED>

<!ELEMENT orderid (#PCDATA)>

<!ELEMENT mbiaid (#PCDATA)>

<!ELEMENT tradeamt (#PCDATA)>

<!ELEMENT timestamp (#PCDATA)>

Enhanced CUSIP DTD

<!--

<!ELEMENT EnhancedCusip (orderid)>

<!ELEMENT orderid (#PCDATA)>

Error Message DTD

<!--

-->

<!ELEMENT ERROR (msg)>

<!ELEMENT msg (#PCDATA)>

Insurance Quote DTD

<!--

-->

<!-- Municipal Bond Insurance Quote

This is the response from MBIA to a insurance request.

-->

<!ELEMENT InsuranceQuote (orderid, cUSIP, timestamp, ((negative, errorno, errormsg)|(mbiaid, costperbond, totalcost)))>

<!ELEMENT orderid (#PCDATA)>

<!ELEMENT cUSIP (#PCDATA)>

<!ELEMENT timestamp (#PCDATA)>

<!ELEMENT negative EMPTY>

<!ELEMENT mbiaid (#PCDATA)>

<!ELEMENT costperbond (#PCDATA)>

<!ELEMENT totalcost (#PCDATA)>

<!ELEMENT errorno (#PCDATA)>

<!ELEMENT errormsg (#PCDATA)>

Initial Request for Insurance DTD

<!--

This is the initial request for insurance from BondLink to MBIA.

-->

<!-- Municipal Bond Insurance Request -->

<!ELEMENT InsuranceRequest (orderid, customerid, CUSIP, paramt, timestamp)>

<!-- Possible types of Insurance are INSURANCE_ONLY and INSURANCE_TXN

->

<!ATTLIST InsuranceRequest type CDATA #REQUIRED>

<!ELEMENT orderid (#PCDATA)>

<!ELEMENT customerid (#PCDATA)>

<!ELEMENT CUSIP (#PCDATA)>

<!ELEMENT paramt (#PCDATA)>

<!ELEMENT timestamp (#PCDATA)>

Insurance Confirmation DTD

Note, the enhancedcusip may be “WHOLE”, “PENDING”, or the enhanced CUSIP itself.

If PENDING, then MBIA will send Trading Edge an MBIAConfirmation.xml at some point in the future.

-->

<!-- Municipal Bond Confirmation from MBIA ->

<!ELEMENT MBIAConfirmation (orderid, mbiaid, timestamp, ((negative, errorno, errormsg)|(enhancedcusip, policy)))>

<!-- Resonse can be POSITIVE or NEGATIVE-->

<!ATTLIST MBIAConfirmation response CDATA #REQUIRED>

<!ELEMENT orderid (#PCDATA)>

<!ELEMENT mbiaid (#PCDATA)>

<!ELEMENT timestamp (#PCDATA)>

<!ELEMENT negative EMPTY>

<!ELEMENT enhancedcusip (#PCDATA)>

<!ELEMENT policy (#PCDATA)>

<!ELEMENT errorno (#PCDATA)>

<!ELEMENT errormsg (#PCDATA)>

### SUMMARY

Although various embodiments are specifically illustrated and described herein, it will be appreciated that modifications and variations of the invention are covered by the above teachings and within the purview of the appended claims without departing from the spirit and intended scope of the invention. For example, while several of the embodiments depict the use of specific computers and operating systems, other computers and operating systems may suffice. In addition, while several of the embodiments discuss the use of specific communication protocols, other protocols may suffice for the same purposes. Furthermore, these examples should not be interpreted to limit the modifications and variations of the invention covered by the claims but are merely illustrative of possible variations.

What is claimed is:

1. A computer-based electronic trading system for trading one or more of a plurality of debt instruments, including one or more of a plurality of bonds, comprising:
a plurality of computers via which one or more of a plurality of traders enters a plurality of trading orders for one or more of the plurality of debt instruments, each of which plurality of computers executes a client application;
a central controller coupled to the plurality of computers and matching buy orders and sell orders for a same one of the one or more of the plurality of debt instruments in a price, time priority basis, and reporting all matched buy orders and sell orders as a plurality of executed trades to each of the plurality of traders via the plurality of computers.

2. The system according to claim 1, further comprising:
a database coupled to the central controller and storing all bids and offers for each of the one or more of the plurality of debt instruments.

3. The system according to claim 1, wherein said client application:
displays said plurality of executed trades as a scrolling ticker listing said plurality of trades sequentially in time.

4. The system according to claim 1, wherein said client application:
displays a trading order including a plurality of data fields, which when completed by a user, creates a trading order on one side of a prospective trade for one of the plurality of debt instruments, said trading order including a field authorizing broadcast of at least part of the trading order to all of the plurality of traders.

5. The system according to claim 1, wherein said controller forwards all trading orders authorized for broadcast to each of the plurality of computers without disclosing an identity of each trader associated with each trading order being broadcast.

6. The system according to claim 1, wherein said client application displays all received trading orders forwarded from the controller for broadcast.

7. The system according to claim 1, wherein said client application submits a completed trading order to the central controller under control of a user.

8. The method according to claim 1, wherein said client application automatically completes a contra trading order upon selection by a user of a particular bid or offer being displayed by the client application.

9. The system according to claim 1, further comprising a computer network coupling the plurality of computers to the controller.

10. The system according to claim 9, wherein the computer network includes the Internet.

11. The system according to claim 1, where said controller creates an audit trail for each transaction entered into the system.

12. The system according to claim 11, wherein said audit trail includes an immutable record of every database modification that occurs in the system.

13. The system according to claim 12, wherein said record of every database modification includes tracing each data record that was changed, when each data record was changed and the value of the data record before and after the change.

14. A computer-based method for electronically trading one or more debt instruments, including one or more bonds, comprising:
entering a plurality of trading orders for one or more of the plurality of debt instruments into a plurality of computers;
matching buy orders and sell orders for a same one of the one or more debt instruments in a price, time priority basis;
reporting all matched buy orders and sell orders as a plurality of executed trades to each of the plurality of traders.

15. The method according to claim 14, further comprising:
storing all bids and offers for each of the one or more of the plurality of debt instruments.

16. The method according to claim 14, further comprising:
displaying to the plurality of traders the plurality of executed trades as a scrolling ticker listing said plurality of trades sequentially in time.

17. The method according to claim 14, further comprising:
displaying a trading order including a plurality of data fields;
submitting a trading order when completed by a user on one side of a prospective trade for one of the plurality of debt instruments.

18. The method according to claim 17, further comprising:
authorizing broadcast of at least part of the trading order to all of the plurality of traders.

19. The method according to claim 18, further comprising:
forwarding all trading orders authorized for broadcast to each of the plurality of computers without disclosing an identity of each trader associated with each trading order being broadcast.

20. The method according to claim 19, further comprising:
displaying all received trading orders forwarded from the controller for broadcast.

21. The method according to claim 20, further comprising:
submitting a completed trading order to the central controller under control of a user; and
completing automatically a contra trading order upon selection by a user of a particular bid or offer being displayed by the client application.

22. The method according to claim 21, further comprising coupling the plurality of computers to the controller via a public computer network.

23. The method according to claim 14, further comprising communicating between the plurality of traders and a central controller over a computer network.

24. The method according to claim 23, wherein the computer network includes a public computer network.

25. The method according to claim 14, further comprising creating an audit trail for each transaction.

26. The method according to claim 25, wherein creating an audit trail includes creating an immutable record of every database modification.

27. The method according to claim 26, wherein creating an immutable record includes creating the immutable record includes tracing each data record that was changed, when each data record was changed and the value of the data record before and after the change.

28. An method for trading bonds comprising:
entering a buy order for a particular instrument and an order for insurance for the particular instrument simultaneously;
submitting the buy order to an electronic trading system; and
submitting the insurance order to an insurance provider via the electronic trading system.

29. The method according to claim 28, further comprising:
submitting a request for an insurance quote to an insurance provider via the electronic trading system upon entering the buy order;
accepting a quote from the insurance provider and submitting a buy order to the electronic trading system.

30. A method for purchasing an insurable instrument comprising:
creating a buy order for the insurable instrument, said buy order including a request for a quote for the insurable instrument;
submitting the request for a quote to an insurance provider;
receiving a quote from the insurance provider; and
submitting the buy order to the electronic trading.

31. The method according to claim 30, further comprising:
accepting the quote while simultaneously submitting the buy order to the electronic trading system.

32. A method for trading an insurable instrument comprising:
entering an order for the insurable instrument into an order processing system; and
offering insurance for the insurable instrument at a point of sale of the insurable instrument.

33. A method for trading an insurable instrument comprising:
entering an order for the insurable instrument into an electronic trading system;
submitting a request for an insurance quote from a plurality of insurance providers as part of the order for the insurable instrument; and
accepting at least one of a plurality of quotes from one of a plurality of responses from the plurality of insurance providers.

34. An apparatus for trading insurable instruments comprising:
at least one workstation executing a client application enabling a user to enter simultaneously an order for at least one insurable instrument and a request for a quote on insurance for the insurable instrument;
a central controller receiving the order for the insurable instrument and the request for the quote; and
an insurance provider interface coupling the central controller to one or more insurance providers via which said central controller forwards the request for the quote and via which said controller receives one or more quotes from the one or more insurance providers.

35. The apparatus according to claim 34, wherein said central controller forwards the received quotes from the one or more insurance providers to the at least one workstation.

36. The apparatus according to claim 35, wherein said client application enables the user to accept or decline one of the one or more quotes from the one or more insurance providers.

37. The apparatus according to claim 34, wherein the insurance provider interface includes a server.

38. The apparatus according to claim 37, wherein the server communicates with one or more computers located in the one or more insurance providers using a predetermined protocol having a predetermined format.

39. The apparatus according to claim 38, wherein the predetermined protocol is an extensible markup language (XML) and the predetermined format includes a plurality of document type definitions specifying a plurality of message formats.

40. A computer-based trading method for trading a plurality of different types of bond instruments, comprising:
enabling a trader to submit an order completely anonymously;
enabling a user to submit an order and control an amount of the order that is disclosed to other traders;
matching buy orders to sell orders using a price/time priority.

41. The method according to claim 40, wherein the plurality of different types of bond instruments include one or more of the following: high-yield bonds, corporate bonds, emerging market bonds, convertible bonds, derivative instruments comprised of bonds, and municipal bonds.

42. The method according to claim 40, further comprising reporting every executed trade to all users in a scrolling ticker continually updated in each user's graphical user interface, there being one scrolling ticker for each bond instrument type.

43. An apparatus for trading a plurality of bond instruments comprising an Internet-based bond trading system including:
a plurality of clients entering orders anonymously for one or more of the plurality of bond instruments and enabling a trader to control an amount of an order that is disclosed to other traders; and
one or more servers coupled to the plurality of clients via a public computer network, said one or more servers restricting access to authorized clients, said one or more servers maintaining an audit trail that records every event at the one or more servers and determines what acts authorized users have taken, said one or more servers time stamping all activity, including time of receipt of any order, time of execution, as well as all logins and connection status, said one or more servers recording a state of each record in the server before and after a change.

44. The apparatus according to claim 43, wherein the one or more servers confirm receipt of all orders and transactions to all users, broadcast bids and offers as they are received to all clients and all executed trades to all clients, and said client displays a book of orders for any bond instrument being traded.

45. The apparatus according to claim 43, wherein all orders entered into the system include a price and a quantity and are executable on-line.

46. The apparatus according to claim 43, wherein the one or more servers automatically cancel an order in accordance with any time limit associated with said order.

47. The apparatus according to claim 43, wherein the one or more servers maintain an access control list and permits access to clients included in the access control list.

48. The apparatus according to claim 47, wherein the access control list includes a plurality of user permissions.

49. The apparatus according to claim 43, wherein said plurality of bond instruments include separate markets for high-yield debt, municipal bonds, corporate bonds, emerging market debt, convertible instruments and derivatives.

50. The apparatus according to claim 43, wherein said one or more servers include at least two servers coupled together in a master-slave relationship.

51. A method for transacting in municipal securities and transacting for insurance in conjunction with the municipal securities, comprising:
providing a common interface via which a trader can enter an order for a municipal security and request a quote for insurance on the municipal security;
coupling the common interface to an electronic trading system for trading the municipal security; and
coupling the common interface to an insurance provider for receiving a quote in response to the request for the quote;
enabling a trader to accept or decline the quote via the common interface.

52. The method according to claim 51, further comprising:
entering the order to the electronic trading system anonymously.

53. The method according to claim 51, further comprising entering the request for the quote to the insurance provider without disclosing the request for the quote.
